(19) United States
(12) Patent Application Publication
(10) Pub. No.: US 2007/0122133 A1
(43) Pub. Date: May 31, 2007

(54) Camera system having image shake correction function

(75) Inventor: Kazutoshi Shiratori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS IMAGING CORP., Tokyo (JP)

(21) Appl. No.: 11/602,654

(22) Filed: Nov. 21, 2006

(30) Foreign Application Priority Data
Nov. 28, 2005 (JP) 2005-342922

(51) Int. Cl. G03B 17/00

(52) U.S. Cl. 396/55

(57) ABSTRACT

In a camera system where a taking lens and a camera body respectively comprise a image shake correction unit for correcting a shake, which occurs on an image on an image capturing surface due to a jiggle of the camera system at the time of shooting, the taking lens and the camera body respectively comprise a communication unit for making a communication between the taking lens and the camera body, and a control is performed so that the communication unit of the camera body transmits a lens operation suspension instruction when the image shake correction unit of the camera body is operated, and the operation of the taking lens is suspended when the communication unit of the taking lens receives the lens operation suspension instruction.

### CROSS REFERENCE TO RELATED APPLICATIONS

This application is based upon and claims the benefit of priority from the prior Japanese Patent Application No. 2005-342922, filed Nov. 28, 2005, the entire contents of which are incorporated herein by reference.

### BACKGROUND OF THE INVENTION

1. Field of the Invention

The present invention relates to a camera system the taking lens and the camera body of which are attachable/detachable, and more particularly, to a camera system that enables a image shake correction operation by using part or all of image shake correction functions provided in a taking lens and a camera body.

2. Description of the Related Art

In recent years, a number of camera systems having a image shake correction function have been proposed to improve their operability. For a camera system the taking lens and the camera body of which are attachable/detachable, a camera system where not only a camera body but also a taking lens has an independently operable image shake correction function is proposed. With such a camera system, camera systems having various configurations such as a configuration where both a taking lens and a camera body have a image shake correction function, a configuration where either of a taking lens or a camera body has a image shake correction function and the like can be configured depending on use purpose.

However, the functions of a taking lens and a camera body become diverse as described above, leading to a problem that misoperations, which are caused by a setting mistake, tend to occur, for example, as in a case where a user makes shooting by actually using the image shake correction function of a camera body although he or she is thinking of using the image shake correction function of a taking lens, or a case where the image shake correction functions of both a taking lens and a camera body are simultaneously operated and a proper correction is not made.

Patent Document 1 discloses a camera system where a camera body and a taking lens each having a image shake correction function are connected, and one image shake correction function is stopped when the other image shake correction function is operated.

[Patent Document 1] Japanese laid-open patent application publication No. H05-276429

### SUMMARY OF THE INVENTION

A camera system according to one preferred embodiment of the present invention is a camera system, in which a taking lens and a camera body respectively have a image shake correction unit for correcting a shake, which occurs on an image on an image capturing surface due to a jiggle of the camera system at the time of shooting. The taking lens and the camera body respectively have a communication unit for making a communication between the taking lens and the camera body. In this camera system, a control is performed so that the communication unit of the camera body transmits a lens operation suspension instruction when the image shake correction unit of the camera body is operated, and the operation of the taking lens is suspended when the communication unit of the taking lens receives the lens operation suspension instruction.

### BRIEF DESCRIPTION OF THE DRAWINGS

FIG. 1 is a schematic showing the entire configuration of a camera system according to a first preferred embodiment;

FIG. 2 is a flowchart showing a process for setting an anti-shake mode according to the first preferred embodiment;

FIG. 3 is a flowchart showing the shooting operation of the camera system according to the first preferred embodiment;

FIG. 4 is a schematic explaining an anti-shake operation performed by an anti-shake selection process according to the first preferred embodiment;

FIG. 5 is a flowchart showing the details of the anti-shake selection process of step S307 shown in FIG. 3;

FIG. 6 is a schematic exemplifying a configuration of a camera system having an anti-shake function equivalent to the camera system according to the first preferred embodiment;

FIG. 7 is a schematic exemplifying a configuration of a taking lens of L-0C type shown in FIG. 6;

FIG. 8 is a schematic exemplifying a configuration of a taking lens of L-S0 type shown in FIG. 6;

FIG. 9 is a schematic exemplifying a configuration of a taking lens of L-00 type shown in FIG. 6;

FIG. 10 is a schematic exemplifying a configuration of a camera body of B-0C type shown in FIG. 6;

FIG. 11 is a schematic exemplifying a configuration of a camera body of B-S0 type shown in FIG. 6;

FIG. 12 is a schematic exemplifying a configuration of a camera body of B-00 type shown in FIG. 6;

FIG. 13 is a schematic exemplifying a configuration of a camera system having an anti-shake function equivalent to the camera system according to the first preferred embodiment;

FIG. 14 is a schematic exemplifying a configuration of a converter lens of LC-SC type shown in FIG. 13;

FIG. 15 is a schematic exemplifying a configuration of a converter lens of LC-0C type shown in FIG. 13;

FIG. 16 is a schematic exemplifying a configuration of a converter lens of LC-S0 type shown in FIG. 13;

FIG. 17 is a schematic exemplifying a configuration of a converter lens of LC-00 type shown in FIG. 13;

FIG. 18 is a flowchart showing the shooting operation of a camera system according to a second preferred embodiment;

FIG. 19 is a schematic explaining an anti-shake operation performed by an anti-shake selection process according to the second preferred embodiment;

FIG. 20 is a schematic showing the entire configuration of a camera system according to a third preferred embodiment;

FIG. 21 is a schematic showing a specific example of an anti-shake display according to the third preferred embodiment;

FIG. 22 is a flowchart exemplifying a process for the anti-shake display shown in FIG. 21;

FIG. 23 is a schematic exemplifying a transition of the state of the anti-shake display according to the third preferred embodiment;

FIG. 24 is a schematic exemplifying a case where the anti-shake display according to the third preferred embodiment is made on a liquid crystal monitor;

FIG. 25 is a schematic exemplifying a case where the anti-shake display according to the third preferred embodiment is made on a display panel;

FIG. 26 is a schematic exemplifying a case where the anti-shake display according to the third preferred embodiment is made on a finder; and

FIG. 27 is a schematic exemplifying data transmitted with communication operations.

### DESCRIPTION OF THE PREFERRED EMBODIMENTS

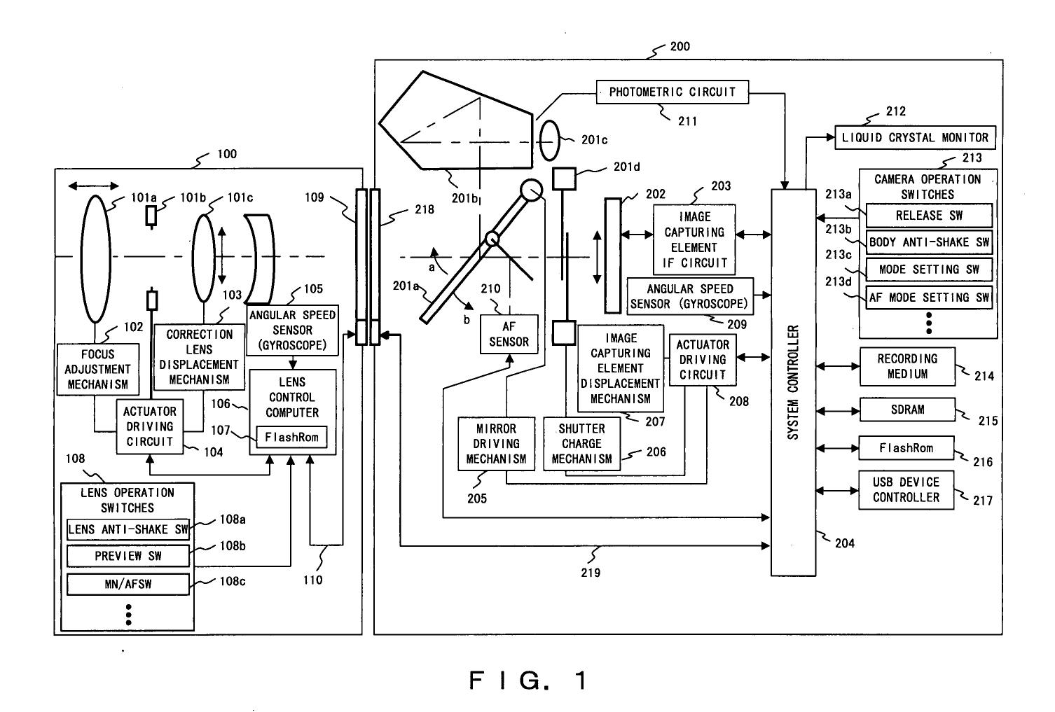

Preferred embodiments according to the present invention are hereinafter described with reference to FIGS. 1 to 27. The first, the second, and the third preferred embodiments are described with reference to FIGS. 1 to 17 and 27, FIGS. 18 and 19, and FIGS. 20 to 26 respectively.

### (1) First Preferred Embodiment

FIG. 1 is a schematic showing the entire configuration of a camera system according to the first preferred embodiment.

The camera system shown in FIG. 1 is configured with a taking lens 100 and a camera body 200, which are connected to be mutually attachable/detachable.

The taking lens 100 comprises an optical system having at least a focus lens 101a for adjusting a focus, an aperture 101b for restricting the amount of incident light, and a correction lens 101c for changing the optical axis of the incident light.

The taking lens 100 also comprises a focus adjustment mechanism 102 for adjusting a focus by moving the focus lens 101a in the direction of the optical axis, a correction lens displacement mechanism 103 for displacing the correction lens 101c on a plane vertical to the optical axis or for tilting the correction lens 101c, an actuator driving circuit 104 for driving the aperture 101b, the focus adjustment mechanism 102 and the correction lens displacement mechanism 103, an angular speed sensor 105 for detecting the shake (image shake) of the taking lens 100, a lens control computer 106 for controlling the optical system of the taking lens 100 according to an instruction from the camera body 200 and for performing an anti-shake operation, a FlashRom 107 for storing a program for operating the lens control computer 106, and parameters such as the focal distance of the lens, etc., and lens operation switches 108, which are a switch group for the settings of the taking lens.

In the above described configuration, the lens operation switches 108 include at least a lens anti-shake SW 108a for setting the validity/invalidity of the image shake correction function (hereinafter referred to as an anti-shake function) of the taking lens 100, a preview SW 108b for driving the aperture 101b regardless of the shooting operation, and an MN/AFSW 108c for switching between manual focus and auto focus.

The lens control computer 106 makes the actuator driving circuit 104 drive, according to an instruction from the camera body 200, to operate the aperture 101b, the focus adjustment mechanism 102 or the correction lens displacement mechanism 103.

Additionally, the lens control computer 106 calculates the amount of image shake by performing an integration process for an angular speed measured by the angular speed sensor 105. Then, the lens control computer 106 makes the actuator driving circuit 104 and the correction lens displacement mechanism 103 drive so that the amount of image shake is corrected. As a result, the correction lens 101c is displaced, and also the optical axis is displaced to correct the amount of image shake.

In the meantime, the camera body 200 comprises an optical system having a quick return mirror 201a for switching the optical path of light incident from the taking lens 100, a pentaprism 201b for transmitting the light reflected from the quick return mirror 201a to an eyepiece lens, the eyepiece lens 201c, and a shutter 201d for controlling exposure to an image capturing element 202.

The camera body 200 also comprises the image capturing element 202 for converting the image of a subject, which is obtained by being formed with incident light exposed via the shutter 201d, into an electric signal, an image capturing element IF (InterFace) circuit 203 for generating a digital signal from the electric signal obtained with the image capturing element 202, and a system controller 204 for generating image data from the digital signal generated with the image capturing element IF circuit 203 and for controlling the whole of the camera system.

The camera body 200 further comprises a mirror driving mechanism 205 for driving the quick return mirror 201a, a shutter charge mechanism 206 for opening/closing the shutter 201d, an image capturing element displacement mechanism 207 for displacing the image capturing element 202 on a plane vertical to the optical axis of the incident light, an actuator driving circuit 208 for driving the mirror driving mechanism 205, the shutter charge mechanism 206 and the image capturing element displacement mechanism 207, an angular speed sensor 209 for detecting the shake (image shake) of the camera body 200, an AF (Auto Focus) sensor 210 for measuring a distance to a subject, and a photometric circuit 211 for photometry.

The camera body 200 still further comprises a liquid crystal monitor 212 for displaying the image of a subject, which is obtained via the image capturing element 202 and the image capturing element IF circuit 203, the state of the camera system, etc., camera operation switches 213, which are a group of various types of switches, for setting the validity/invalidity of the anti-shake function and the state of the camera system, a recording medium 214 for recording image data generated with the system controller 204, an SDRAM 215 for storing data, etc. used by a program running within the system controller 204, a FlashRom 216 for storing a program running within the system controller 204 and parameters such as the state of the camera system, etc., and a USB (Universal Serial Bus) device controller 217 for connecting the camera body 200 and an external device such as an information processing device, etc. via a USB.

In the above described configuration, the camera operation switches 213 include at least a release SW 213a (a 1st release SW for issuing a shooting preparation operation start instruction and a 2nd release SW for issuing a shooting operation start instruction), which is pressed in two steps to start a shooting operation, a body anti-shake SW 213b for setting the validity/invalidity of the anti-shake function of the camera body 200, a mode setting switch SW 213c for setting the operation state of the camera system, and an AF mode setting SW 213d for setting the AF mode of the camera system. The body anti-shake SW 213b, the mode setting SW 213c, and the AF mode setting SW 213d may be implemented by using a liquid crystal monitor 212 having a touch sensor function.

The mode setting SW 213c sets a priority to the setting of the lens anti-shake SW 108a included by the lens operation switches 108, and the setting of the body anti-shake SW 213b included by the camera operation switches 213. For example, if the anti-shake function is comprised by both the taking lens 100 and the camera body 200, the mode setting SW 213c can select either of the anti-shake functions to operate with higher priority. The AF mode setting SW 213d sets one AF mode from among a plurality of AF modes including a moving subject predictive AF mode to be described in detail later.

Hereinafter, a mode for operating the lens anti-shake function by giving a higher priority to the setting of the lens anti-shake SW 108a is referred to as a lens priority mode, whereas the mode for operating the body anti-shake function by giving a higher priority to the setting of the body anti-shake SW 213b is referred to as a body priority mode. Additionally, the lens priority mode and the body priority mode are generically referred to as an anti-shake mode.

The taking lens 100 and the camera body 200 are connected to be attachable/detachable with an L (Lens) mount 109 and a B (Body) mount 218, so that the optical system comprised by the taking lens 100 and that comprised by the camera body 200 are linked.

Additionally, a lens side communication line 110 comprised by the taking lens 100 and a body side communication line 219 comprised by the camera body 200 are connected via the L mount 109 and the B mount 218, so that the lens control computer 106 and the system controller 204 can make a communication.

Note that the lens control computer 106 and the system controller 204 respectively comprise a communication unit for making a communication with a device electrically connected, although this is not shown. A communication is made between the communication unit of the lens control computer 106 and that of the system controller 204, whereby a communication between the lens control computer 106 and the system controller 204 can be made.

In the above described configuration, a vibratory gyroscope, which is an angular speed sensor using Coriolis force, is used as the angular speed sensors 105 and 209 according to this preferred embodiment.

The system controller 204 makes the actuator driving circuit 208 drive, according to an output from a camera operation switch 213, to operate the mirror driving mechanism 205 and the shutter charge mechanism 206.

Additionally, the system controller 204 calculates the amount of image shake by performing an integration process for the angular speed measured by the angular speed sensor 209, and makes the actuator driving circuit 208 drive to operate the image capturing element displacement mechanism 207 so that the amount of image shake is corrected. As a result, an image formed on the image capturing element 202 is prevented from degrading due to a image shake.

Furthermore, the system controller 204 calculates the amount of focus adjustment according to an output from the AF sensor 210, and issues an instruction to the taking lens 100 (lens control computer 106). Still further, the system controller 204 calculates the amount of aperture according to an output from the photometric circuit 211, and issues an instruction to the taking lens 100 (lens control computer 106).

The above described taking lens 100 and camera body 200 can operate their anti-shake functions independently of each other. Namely, the taking lens 100 can perform its anti-shake operation only with itself, and accordingly, a camera system that can perform an anti-shake operation can be configured regardless of whether or not the anti-shake function is comprised by the camera body 200 to be attached.

Similarly, the camera body 200 can perform its anti-shake operation only with itself, and a camera system that can perform an anti-shake operation can be configured regardless of whether or not the anti-shake function is comprised by the taking lens 100 to be attached.

Here, the anti-shake function of the taking lens 100 is implemented mainly with the correction lens 101c, the correction lens displacement mechanism 103, the actuator driving circuit 104, the angular speed sensor 105 and the lens control computer 106. In the meantime, the anti-shake function of the camera body 200 is implemented mainly with the image capturing element 202, the system controller 204, the image capturing element displacement mechanism 207, the actuator driving circuit 208 and the angular speed sensor 209.

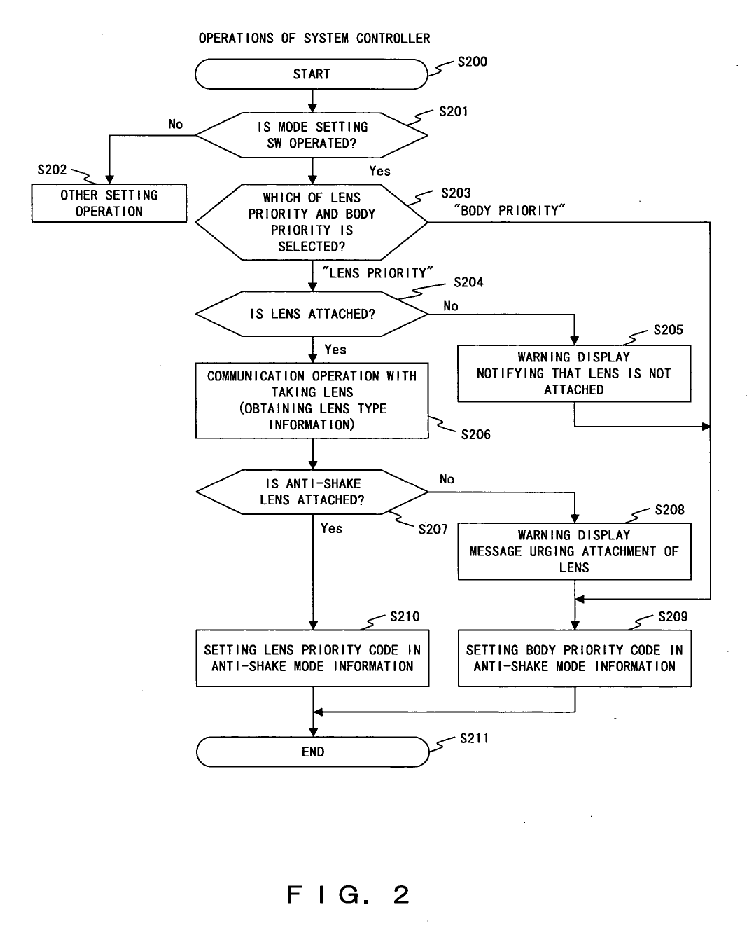

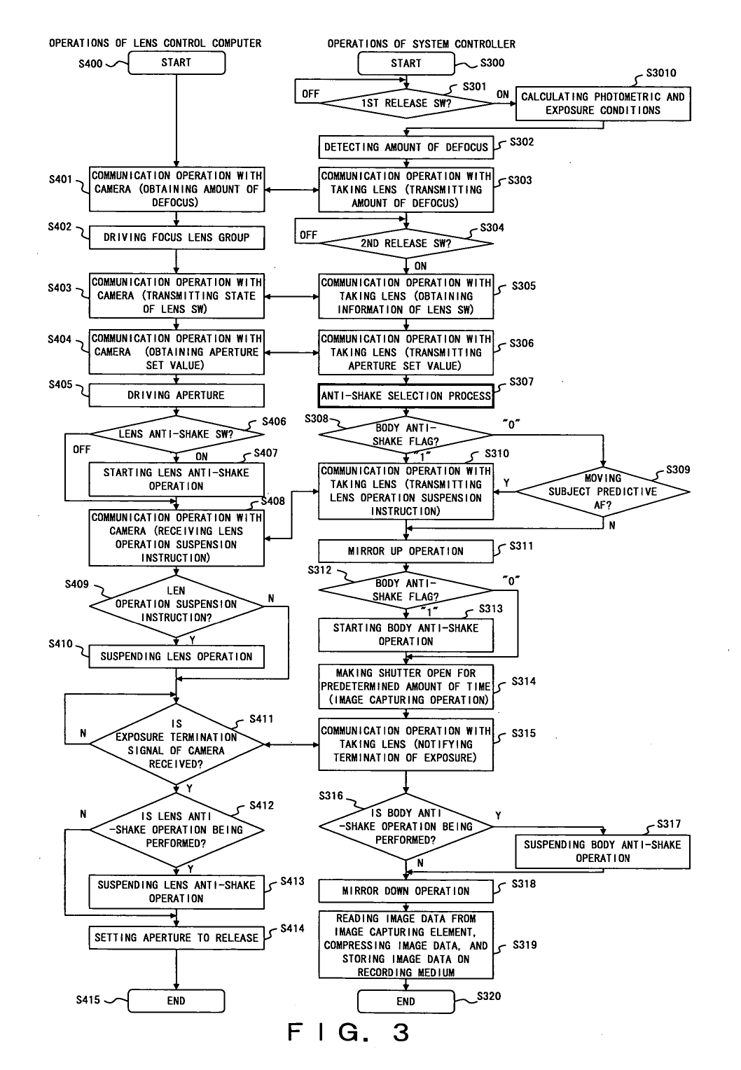

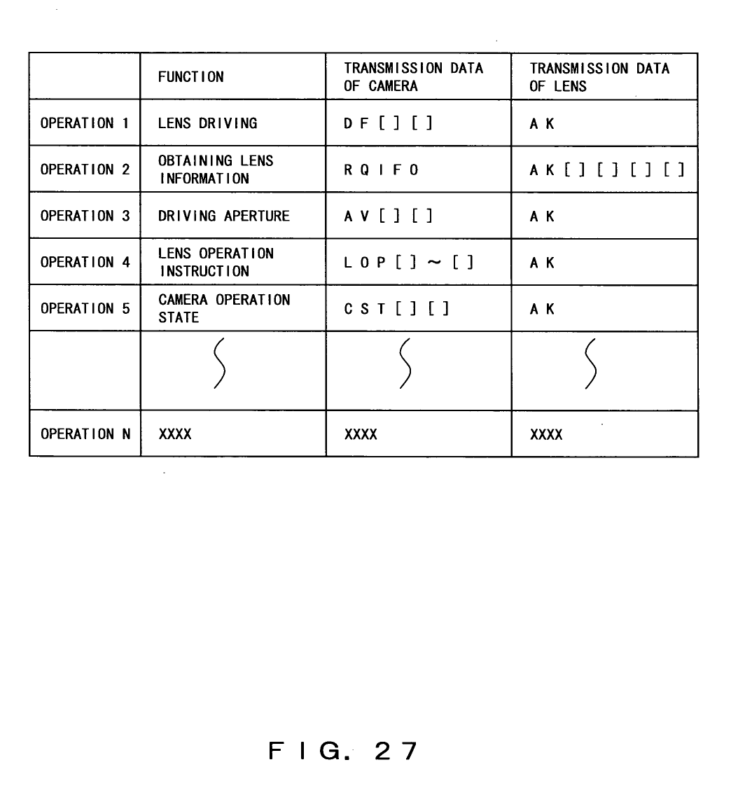

For the camera system having the above described configuration, a process for setting an anti-shake mode with the mode setting SW 213c is first described with reference to FIG. 2, a communication made between the system controller 204 for controlling the camera body 200 and the lens control computer 106 for controlling the taking lens 100 is next described with reference to FIG. 27, and a process for operating the anti-shake function according to the anti-shake mode is described with reference to FIGS. 3 to 5.

FIG. 2 is a flowchart showing the process for setting the anti-shake mode.

When a camera operation switch 213 is operated, for example, an interrupt signal is input to the system controller 204. An MPU comprised by the system controller 204 executes a program stored at a predetermined address within the FlashRom 216 according to the interrupt signal, so that the process for setting the anti-shake mode is started (step S200).

The process described below is implemented in a way such that the MPU within the system controller 204 executes instructions written in a predetermined program. However, for ease of explanation, the process is described by assuming the system controller 204 to be the main entity of the process.

In step S201, the system controller 204 determines whether or not the mode setting SW 213c is operated. If a camera operation switch 213 other than the mode setting SW 213c is operated, the system controller advances the process to step S202 to start a process according to each camera operation switch 213.

If the mode setting SW 213c is operated, the system controller 204 advances the process to step S203. Then, the system controller 204 obtains the setting of the mode setting SW 213c, and determines whether the obtained setting is either the lens priority mode or the body priority mode.

If the setting is the lens priority mode, the system controller 204 advances the process to step S204. Or, if the setting is the body priority mode, the system controller 204 advances the process to step S209.

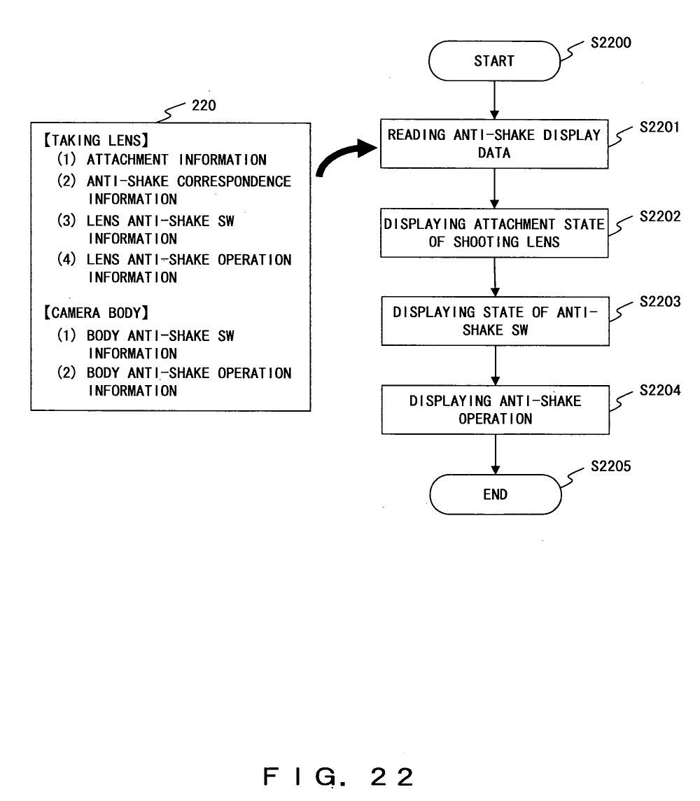

In step S204, the system controller 204 determines whether or not the taking lens 100 is attached, and stores the result of the determination in attachment information of state display data (hereinafter referred to as anti-shake display data 220), which is stored in the FlashRom 216. The anti-shake display data 220 will be described in detail with reference to FIG. 22.

If the taking lens 100 is not attached, the system controller 204 advances the process to step S205 to display a message, which indicates that the taking lens 100 is not attached, for example, on the liquid crystal monitor 212 or the like (makes a user recognize that the taking lens 100 is not attached).

Whether or not the taking lens 100 is attached may be determined, for example, according to the presence/absence of a response to a communication made between the system controller 204 and the lens control computer 106. Namely, if the response from the lens control computer 106 is not received within a predetermined amount of time, it may be determined that the taking lens 100 is not attached.

If the taking lens 100 is attached in step S204, the system controller 204 advances the process to step S206. Then, the system controller 204 obtains lens type information by making a communication with the lens control computer 106, and stores, in anti-shake correspondence information of the anti-shake display data 220, information indicating that the attached taking lens 100 has/does not have the anti-shake function.

For example, the system controller 204 makes a request of lens type information to the lens control computer 106. In the meantime, the lens control computer 106 reads the lens type information stored at a predetermined address of the FlashRom 107, and transmits the read information to the system controller 204. The system controller 204 determines based on the received lens type information whether or not the taking lens 100 has the anti-shake function, and stores the result of the determination in the anti-shake correspondence information of the anti-shake display data 220.

The lens type information includes at least the type of the taking lens 100, for example, information identifying whether or not the taking lens 10 has the anti-shake function (hereinafter referred to as an anti-shake lens). The lens type information is prestored at a predetermined address of the FlashRom 107.

After obtaining the lens type information of the attached taking lens 100 in step S206, the system controller 204 advances the process to step S207. Then, the system controller 204 determines based on the lens type information whether or not the taking lens 100 is an anti-shake lens.

If the taking lens 100 is not the anti-shake lens, the system controller 204 advances the process to step S208 to display a warning message such as “Attached taking lens is not an anti-shake lens. Attach the anti-shake lens”, for example, on the liquid crystal monitor 212 or the like.

After displaying the warning message on the liquid crystal monitor 212 or the like in step S208, the system controller 204 advances the process to step S209. Then, the system controller 204 sets the anti-shake mode information, which is stored at the predetermined address of the FlashRom 216, to the body priority mode, and terminates the process (step S211).

Or, if the taking lens 100 is the anti-shake lens in step S207, the system controller 204 advances the process to step S210. Then, the system controller 204 sets the anti-shake mode information to the lens priority mode, and terminates the process (step S211).

Prior to a specific explanation of the shooting operation of the camera system, communication operations performed between the system controller 204 for controlling the camera body 200 and the lens control computer 106 for controlling the taking lens 100 are described with reference to FIG. 27.

FIG. 27 is a schematic exemplifying data transmitted with the communication operations.

In this figure, an “operation 1” is performed when the camera body 200 drives the taking lens 100 to perform a focus adjustment operation. With the operation 1, the system controller 204 transmits “DF[ ] [ ]” to the lens control computer 106 by using character code. “DF” indicates that transmitted data is the amount of defocus (DeFocus) in a focal position. In “[ ] [ ]” succeeding “DF”, a value indicating the amount of defocus in the focal position is set. Upon receipt of these items of information, the lens control computer 106 returns “AK (AcKnowledge)” by using character code. Then, the lens control computer 106 drives the taking lens based on the received amount of defocus.

An “operation 2” is performed when the camera body 200 obtains lens information. With the “operation 2”, the system controller 204 transmits “RQIFO (ReQuest InFOrmation) ” to the lens control computer 106. The lens control computer 106 that receives this information returns “AK[ ] [ ] [ ] [ ]”. In “[ ] [ ] [ ] [ ]” succeeding “AK”, the state of the lens (the operation state of SW on the lens side) and lens parameters (focal distance, the type of lens, maximum aperture and the like) are set.

An “operation 3” is performed when the camera body 200 sets the aperture of the lens. With the “operation 3”, the system controller 204 transmits “AV[ ] [ ]”. “AV” indicates that transmitted data is an aperture set value (Aperture Value). In “[ ] [ ]” succeeding “AV”, the value of aperture to be set is set. Upon receipt of these items of information, the lens control computer 106 returns “AK”. Then, the lens control computer 106 drives the aperture based on the received set value of aperture.

An “operation 4” is performed when a lens operation (a lens driving operation for a focus adjustment, a correction lens driving operation for a shake correction, or an operation for driving the aperture) is suspended and started. With the “operation 4”, the system controller 204 transmits “LOP[ ]˜[ ]”. “LOP” indicates that transmitted data is a lens operation (Lens OPeration). In “[ ]˜[ ]” succeeding “LOP”, “SP (StoP)” is set when the lens operation is suspended, or “ST (StarT)” is set when the lens operation is started. Or, if the amount of time until a suspension is set, “SP50” is set (for example, in a case where the amount of time of 50 msec is set). The lens control computer 106 that receives this information returns “AK”. Then, the lens control computer 106 controls the lens operation based on the data.

An “operation 5” is used to notify the lens control computer 106 of the operation state of the camera. With the “operation 5”, the system controller 204 transmits “CST[ ] [ ]”. “CST” indicates a camera state (Camera STate). In “[ ] [ ]” succeeding “CST”, a specific operation and data indicating its state are set. For example, when a notification that the exposure operation of the camera is terminated is made, “EE” (Exposure End) is set.

FIG. 3 is a flowchart showing the shooting operation of the camera system according to the first preferred embodiment. An anti-shake operation of the camera system according to the first preferred embodiment is described below with reference to this flowchart.

When a camera operation switch 213 is operated, for example, an interrupt signal is input to the system controller 204, and the MPU comprised by the system controller 204 executes a program stored at a predetermined address within the FlashRom 216, so that the shooting operation, etc. are started (step S300).

The process described below is implemented in a way such that the MPUs respectively comprised by the lens control computer 106 and the system controller 204 execute instructions written in a predetermined program. However, for ease of explanation, this process is described by assuming the lens control computer 106 and the system controller 204 to be the main entities of the process.

When the shooting operation is started, the system controller 204 checks whether or not the 1st release SW is turned on with the release SW 213a. If the 1st release SW is not turned on (in OFF state), the system controller 204 repeats the process of step S301 until the 1st release SW is turned on.

When the 1st release SW is turned on in step S301, the system controller 204 advances the process to step S3010. Then, the system controller 204 calculates exposure conditions (an aperture set value and a shutter time) from the output value of the photometric circuit 211. In step S302, the system controller 204 calculates the amount of defocus from the output value of the AF sensor 210.

Upon completion of the calculation of the amount of defocus, etc., the system controller 204 advances the process to step S303. Via a communication with the lens control computer 106 comprised by the taking lens 100, the system controller 204 notifies the lens control computer 106 of the amount of defocus calculated in step S302.

In the meantime, after obtaining the amount of defocus via the communication with the system controller 204 in step S401, the lens control computer 106 advances the process to step S402. Then, the lens control computer 106 makes the actuator driving circuit 104 drive to adjust the position of the focus lens 101a according to the obtained amount of defocus.

Upon completion of the transmission of the amount of defocus in step S303, the system controller 204 advances the process to step S304.

Then, the system controller 204 checks whether or not the 2nd release SW is turned on with the release SW 213a. If the 2nd release SW is not turned on (in OFF state), the system controller 204 repeats the process of step S304 until the 2nd release SW is turned on.

After the 2nd release SW is turned on in step S304, the system controller 204 advances the process to step S305. Then, the system controller 204 obtains the setting information of the lens operation switches 108 by making a communication with the lens control computer 106 of the taking lens 100. The setting of the lens anti-shake SW 108a within the obtained information of the lens operation switches 108 is stored in the lens anti-shake SW information of the anti-shake display data 220.

In the meantime, in step S403, the lens control computer 106 reads the setting information of the lens operation switches 108 by request of the setting information of the lens operation switch 108 from the system controller 204, and transmits the read information to the system controller 204.

After obtaining the setting information of the lens operation switches 108 from the lens control computer 106 in step S305, the system controller 204 advances the process to step S306. Then, the system controller 204 transmits the aperture set value calculated in step S302 to the lens control computer 106.

In the meantime, after obtaining the aperture set value transmitted from the system controller 204 in step S404, the lens control computer 106 advances the process to step S405. Then, the lens control computer 106 makes the actuator driving circuit 104 drive to adjust the aperture 101b according to the aperture set value.

Upon termination of the adjustment of the aperture 101b in step S405, the lens control computer 106 advances the process to step S406, and determines the lens anti-shake SW 108a. If the lens anti-shake SW 108a is in ON state, the lens control computer 106 advances the process to step S407. Or, if the lens anti-shake SW 108a is in OFF state, the lens control computer 106 advances the process to step S408.

In step S407, the lens control computer 106 starts the anti-shake operation of the lens. Then, the lens control computer 106 advances the process to step S408.

Upon completion of the transmission of the aperture set value to the lens control computer 106 in step S306, the system controller 204 advances the process to step S307 to perform an anti-shake selection process for selecting which of the anti-shake function comprised by the taking lens 100 (hereinafter referred to as a lens anti-shake) and the anti-shake function comprised by the camera body 200 (hereinafter referred to as a body anti-shake) to use.

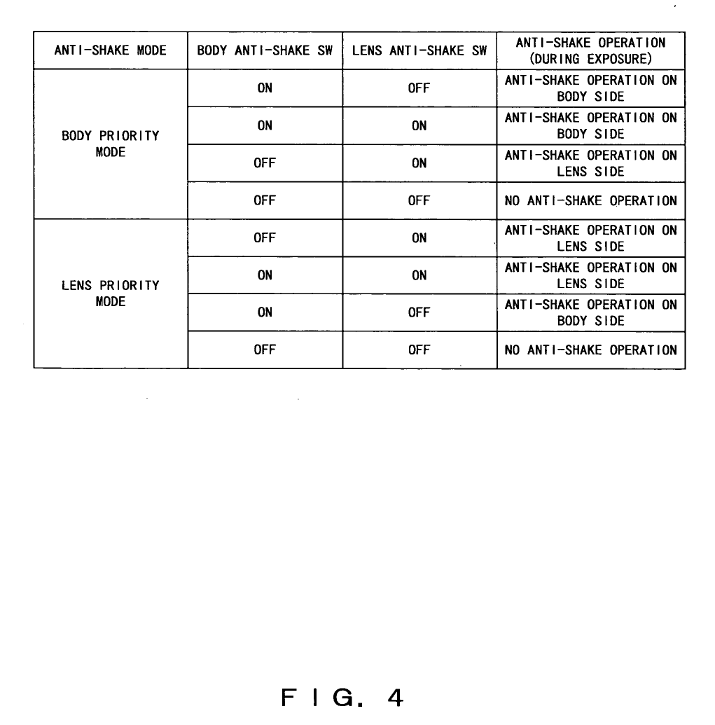

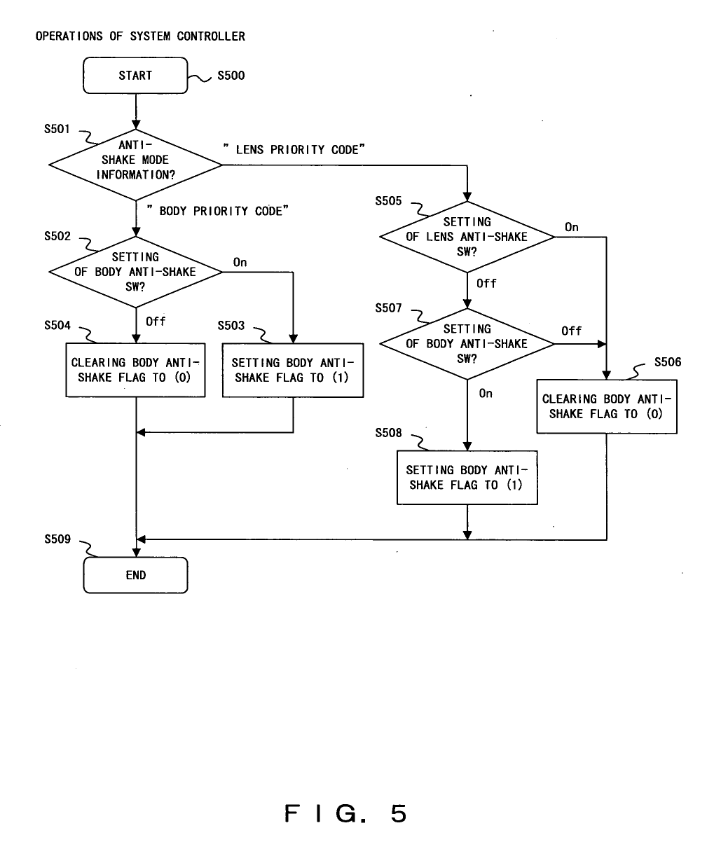

In step S307, the system controller 204 performs the anti-shake selection process based on the setting information of the lens anti-shake SW 108a, which is obtained in step S305, the setting information of the body anti-shake SW 213b, and the anti-shake mode described with reference to FIG. 2. Details of the anti-shake selection process will be described later with reference to FIGS. 4 and 5.

At this time, for example, when selecting the body anti-shake, the system controller 204 sets a code, which represents “under operation”, in the body anti-shake operation information of the anti-shake display data 220, and stores a code, which represents “under suspension”, in the lens anti-shake operation information.

Upon completion of the anti-shake selection process in step S307, the system controller 204 advances the process to step S308, and determines a body anti-shake flag. If the body anti-shake flag is 1, the system controller 204 advances the process to step S310. Or, if the body anti-shake flag is 0, the system controller 204 advances the process to step S309.

In step S309, the system controller 204 determines based on the state of the AF mode setting SW 213d whether or not a set AF mode is a moving subject predictive AF mode. If the set AFmode is the moving subject predictive AF mode, the system controller 204 advances the process to step S310. Otherwise, the system controller 203 advances the process to step S311.

In the moving subject predictive AF mode, the system controller 204 detects a time change in a subject distance from a time change in the output of the AF sensor 210. Then, the system controller 204 continually predicts the moved position of the focus lens 101a, which focuses on a subject after a predetermined amount of time equivalent to a release time lag elapses, and drives the focus lens 101a. In this mode, the focus lens 101a is driven to a predicted target moved position also after the 2nd release SW is turned on.

In step S310, the system controller 204 transmits a lens operation suspension instruction to the lens control computer 106. Upon completion of the transmission, the system controller 204 advances the process to step S311. Note that the lens operation suspension instruction also includes the information of an operation suspension time for specifying a predetermined amount of time in order to suspend the operation of the taking lens 100 within the predetermined amount of time (such as 50 ms) from the receipt of the instruction by the lens control computer 106.

In the meantime, in step S408, the lens control computer 106 advances the process to step S409 upon receipt of the lens operation suspension instruction.

In step S409, the lens control computer 106 determines whether or not the received instruction is the lens operation suspension instruction. If the received instruction is not the lens operation suspension instruction, the lens control computer 106 advances the process to step S411. Or, if the received instruction is the lens operation suspension instruction, the lens control computer 106 advances the process to step S410.

In step S410, the lens control computer 106 suspends the operations within the taking lens 100, such as the focus driving (driving of the focus lens 101a), the lens anti-shake operation and the like within the operation suspension time included in the lens operation suspension instruction. If the lens anti-shake operation is suspended at this time, the lens control computer 106 sets a code, which represents “under suspension”, in the lens anti-shake operation information of the anti-shake display data 200. Then, the lens control computer 106 advances the process to step S411.

In step S311, the system controller 204 makes the mirror driving mechanism 205 drive to perform a mirror UP operation for moving the quick return mirror 210a in a direction of a so that incident light is input to the image capturing element 202. This mirror UP operation requires a time (such as 60 ms) slightly longer than the operation suspension time (such as 50 ms), which is included in the lens operation suspension instruction transmitted in step S310. Therefore, upon completion of the mirror UP operation when the body anti-shake is operated, or when the focus driving is continued even after the 2nd release SW is turned on in the moving subject predictive AF mode, all of the driving operations on the side of the taking lens 100 are under suspension. Namely, when the system controller 204 transmits the lens operation suspension instruction (when the lens control computer 106 receives the lens operation suspension instruction), the operations of the taking lens 100 are suspended within a predetermined amount of time shorter than the release time lag of the camera body 200.

Upon completion of the mirror UP operation in step S311, the system controller 204 advances the process to step S312 to determine the body anti-shake flag. Here, if the body anti-shake flag is 1, the system controller 204 advances the process to step S313 to start the body anti-shake operation. Or, if the body anti-shake flag is 0, the system controller 204 advances the process to step S314.

In step S314, the system controller 204 starts the image capturing by making the actuator driving circuit 208 drive to open the shutter 201d.

When a predetermined amount of time elapses, the system controller 204 again closes the shutter 201d, and advances the process to step S315 to notify the lens control computer 106 of the termination of exposure.

In the meantime, when the termination of exposure is notified from the system controller 204 in step S411, the lens control computer 106 advances the process to step S412. If the lens anti-shake operation is being performed, the system controller 204 advances the process to step S413 to suspend the lens anti-shake operation. Additionally, the system controller 204 sets a code, which represents “under suspension”, in the lens anti-shake operation information of the anti-shake display data 220 at this time.

If the lens anti-shake operation is not being performed in step S412 or the suspension of the lens anti-shake operation is complete in step S413, the lens control computer 106 advances the process to step S414. Then, the lens control computer 106 makes the actuator driving circuit 104 drive to releases the aperture 101b, and terminates the process (step S415).

Upon termination of the exposure in step S315, the system controller 204 advances the process to step S316. If the body anti-shake is being operated, the system controller 204 advances the process to step S317 to suspend the body anti-shake. Additionally, the system controller 204 sets the code, which represents “under suspension”, in the body anti-shake operation information of the anti-shake display data 220.

If the body anti-shake is not being operated in step S316 or the suspension of the body anti-shake operation is complete in step S317, the system controller 204 advances the process to step S318. Then, the system controller 204 makes the actuator driving circuit 208 drive to perform a mirror DOWN operation for moving the quick return mirror 201a in a direction of b so that incident light is input to the pentaprism 201b by being reflected on the quick return mirror 201a.

Upon completion of the mirror DOWN operation, the system controller 204 advances the process to step S319. Then, the system controller 204 reads image data from the image capturing element 202 via the image capturing element IF circuit 203, compresses the image data, and stores the image data on the recording medium 214. Additionally, at this time, the anti-shake display data 220 at the time of shooting (for example, at the time of step S314) may be made to correspond to the image data and stored in the header of data conforming, for example, to an Exif standard (hereinafter referred to as Exif data).

Upon completion of the above described process, the shooting operation is terminated (step S320).

FIG. 4 is a schematic explaining the anti-shake operation performed by the anti-shake selection process according to the first preferred embodiment. The anti-shake operation is performed during the exposure operation. An anti-shake operation table shown in FIG. 4 represents a relationship among an anti-shake mode, the body anti-shake SW 213b, the lens anti-shake SW 108a, and an anti-shake operation.

If the anti-shake mode is the body priority mode, and if the body anti-shake SW 213b is in ON state, the body anti-shake is operated regardless of whether the lens anti-shake SW 108a is in either ON or OFF state. Or, if the body anti-shake SW 213b is in OFF state, and if the lens anti-shake SW 108a is in ON state, the lens anti-shake is operated. If both the body anti-shake SW 213b and the lens anti-shake SW 108a are in OFF state, the anti-shake operation is not performed.

Additionally, if the anti-shake mode is the lens priority mode, and if the lens anti-shake SW 108a is in ON state, the lens anti-shake is operated regardless of whether the body anti-shake SW 213b is in either ON or OFF state. Furthermore, if the lens anti-shake SW 108a is in OFF state, and if the body anti-shake SW 213b is in ON state, the body anti-shake is operated. If both the lens anti-shake SW 108a and the body anti-shake SW 213b are in OFF state, the anti-shake operation is not performed.

FIG. 5 is a flowchart showing the details of the anti-shake selection process of step S307 shown in FIG. 3.

Upon completion of the transmission of the aperture set value in step S306 shown in FIG. 3, the system controller 204 advances the process to step S500 to start the anti-shake selection process.

In step S501, the system controller 204 references anti-shake mode information stored at a predetermined address of the FlashRom 216. Then, the system controller 204 determines whether the anti-shake mode is either the lens priority mode or the body priority mode. If the anti-shake mode is the body priority mode (for example, if the body priority code is set in the anti-shake mode information), the system controller 204 advances the process to step S502. Or, if the anti-shake mode is the lens priority mode (for example, if the lens priority code is set in the anti-shake mode information), the system controller 204 advances the process to step S505.

In step S502, the system controller 204 obtains the ON/OFF information of the body anti-shake SW 213b, and stores the obtained ON/OFF information in the body anti-shake SW information of the anti-shake display data 220. If the body anti-shake SW 213b is in ON state, the system controller 204 advances the process to step S503 to set the value of the body anti-shake flag to 1.

At this time, the system controller 204, for example, sets the code, which represents “under operation”, in the body anti-shake operation information of the anti-shake display data 220, and stores the code, which represents “under suspension”, in the lens anti-shake operation information. Then, the system controller 204 terminates the anti-shake selection process (step S509).

Or, if the body anti-shake SW 213b is in OFF state in step S502, the system controller 204 advances the process to step S504 to clear the body anti-shake flag to 0. Then, the system controller 204 terminates the anti-shake selection process (step S509).

In the meantime, when the process advances from step S501 to step S505, the system controller 204 checks the state of the lens anti-shake SW 108a. If the lens anti-shake SW 108a is in ON state, the system controller 204 advances the process to step S506 to clear the body anti-shake flag to 0, and terminates the anti-shake selection process (step S509).

Or, if the lens anti-shake SW 108a is in OFF state in step S505, the system controller 204 advances the process to step S507.

In step S507, the system controller 204 obtains the ON/OFF information of the body anti-shake SW 213b, and stores the obtained ON/OFF information in the body anti-shake SW information of the anti-shake display data 220. If the body anti-shake SW 213b is in OFF state, the system controller 204 advances the process to step S506 to clear the body anti-shake flag to 0, and terminates the anti-shake selection process (step S509). Or, if the body anti-shake SW 213b is in ON state, the system controller 204 advances the process to step S508.

In step S508, the system controller 204 sets the value of the body anti-shake flag to 1. Additionally, the system controller 204, for example, sets the code, which represents “under operation”, in the body anti-shake operation information of the anti-shake display data 220, and stores the code, which represents “under suspension”, in the lens anti-shake operation information. Then, the system controller 204 terminates the anti-shake selection process (step S509).

As described above, the camera system according to this preferred embodiment produces an effect that shooting can be made by operating a desired image shake correction function with a simple operation, which is performed by a user, for setting the mode setting SW 213c to either of the lens priority mode and the body priority mode.

Additionally, an improper correction resultant from the simultaneous operations of the lens anti-shake and the body anti-shake, which are performed when both the lens anti-shake SW 108a and the body anti-shake SW 213b are turned on, can be prevented.

Furthermore, the lens anti-shake operation and the focus driving in the moving subject predictive AF mode are suspended with one communication instruction, the lens operation suspension instruction, whereby a desired control can be performed with a small volume of communication.

In this preferred embodiment, the anti-shake mode (lens priority mode/body priority mode) can be arbitrarily set with the operation of the mode setting SW 213c. However, for example, either of the lens priority mode and the body priority mode may be stored and set as a predetermined mode in the FlashRom 216 or the like, and the stored and set mode may be used as the anti-shake mode.

Additionally, in this preferred embodiment, the states of the lens anti-shake SW 108a and the body anti-shake SW 213b are respectively determined. However, for example, the state of the lens anti-shake SW 108a may not be communicated, and the operation of the anti-shake function may be selected only based on the state of the body anti-shake SW 213b (the mode always results in the body priory mode in this case). Furthermore, also the body anti-shake SW 213b may be abolished, and the body anti-shake function may be operated in all cases.

The above described first preferred embodiment exemplifies the case where both the taking lens 100 and the camera body 200 have the anti-shake function. However, the camera system according to this preferred embodiment can implement the anti-shake function by providing, in either or both of the taking lens 100 and the camera body 200, an angular speed sensor for detecting the amount of image shake, and a correction mechanism for correcting the detected amount of image shake (a correction lens displacement mechanism for displacing an image forming position on a plane vertical to an optical axis, or an image capturing element displacement mechanism for displacing the image capturing element on a plane vertical to the optical axis).

The correction lens displacement mechanism is, for example, a correction optical system implemented with the correction lens 101c, the correction lens displacement mechanism 103, the actuator driving circuit 104 and the lens control computer 106, which are shown in FIG. 1. Meanwhile, the image capturing element displacement mechanism is, for example, a displacement mechanism implemented with the image capturing element 202, the image capturing element displacement mechanism 207, the actuator driving circuit 208 and the system controller 204, which are shown in FIG. 1.

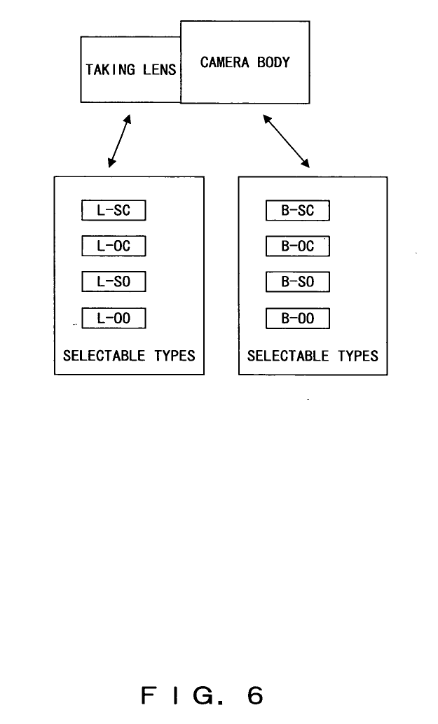

FIG. 6 is a schematic exemplifying a configuration of a camera system having an anti-shake function equivalent to the camera system according to the first preferred embodiment. As shown in FIG. 6, as types of the taking lens 100, a taking lens L-SC comprising a sensor for measuring the amount of image shake, such as an angular speed sensor, etc. (hereinafter referred to simply as a sensor) and a correction mechanism, a taking lens L-0C comprising not a sensor but a correction mechanism, a taking lens L-S0 comprising not a correction mechanism but a sensor, and a taking lens L-00 comprising neither of a sensor and a correction mechanism are considered.

Accordingly, any one of L-SC, L-0C, L-S0 and L-00 can be selected as the taking lens. L, S and C respectively mean Lens, Sensor and Correction. Additionally, 0 means that a sensor or a correction mechanism is not comprised.

Additionally, as types of the camera body 200, a camera body B-SC comprising a sensor and a correction mechanism, a camera body B-0C comprising not a sensor but a correction mechanism, a camera body B-S0 comprising not a correction mechanism but a sensor, and a camera body B-00 comprising neither of a sensor and a correction mechanism are considered.

Accordingly, any one of B-SC, B-0C, B-S0 and B-00 can be selected as the camera body. B, S and C respectively mean Body, Sensor and Correction. 0 means that a sensor or a correction mechanism is not comprised.

A camera system configured with a taking lens and a camera body of the above described types becomes a camera system that can implement the anti-shake function as long as at least one or more of S and C respectively exist in character strings indicating a configured type. Examples include a combination of L-S0 and B-0C, and a combination of L-0C and B-S0.

Here, as a configuration of a camera system that can implement the anti-shake function, a system including a plurality of configurations, which can operate an anti-shake, exists. Examples include a combination of L-S0 and B-SC, and a combination of L-0C and B-SC.

With a camera system implemented with the combination of L-S0 and B-SC, both the sensor comprised by the taking lens and the sensor comprised by the camera body can be used to detect the amount of image shake.

In this case, for example, the process shown in FIG. 2 is performed by using the mode setting SW 213c shown in FIG. 1, and either of the lens priority mode and the body priority mode may be set as the anti-shake mode.

Additionally, for example, the system controller 204 may obtain the type of the taking lens (such as L-S0), which is stored in the FlashRom 107, by making a communication with the lens control computer 106, may read the type of the camera body, which is stored in the FlashRom 216, and may select an angular speed sensor according to the anti-shake mode.

Furthermore, with a camera system implemented with the combination of L-0C and B-SC, the correction lens displacement mechanism comprised by the taking lens or the image capturing element displacement mechanism comprised by the camera body may be used for a correction operation for preventing an image from degrading according to the amount of image shake. A displacement mechanism to be used with higher priority may be made selectable as in the camera system shown in FIG. 1.

Also in this case, for example, the process shown in FIG. 2 is performed by using the mode setting SW 213c shown in FIG. 1, and either of the lens priority mode and the body priority mode may be set as the anti-shake mode.

Then, for example, the system controller 204 may obtain the type of the taking lens (such as L-0C), which is stored in the FlashRom 107, by making a communication with the lens control computer 106, may read the type of the camera body (such as B-SC), which is stored in the FlashRom 216, and may select and operate a displacement mechanism according to the anti-shake mode.

Specific configurations of the taking lenses L-SC, L-0C, L-S0 and L-00 are described below. Subsequently, specific configurations of the camera bodies B-SC, B-0C, B-S0 and B-00 are described. However, since L-SC and B-SC respectively indicate the taking lens 100 and the camera body 200, which are described with reference to FIG. 1, their explanations are omitted.

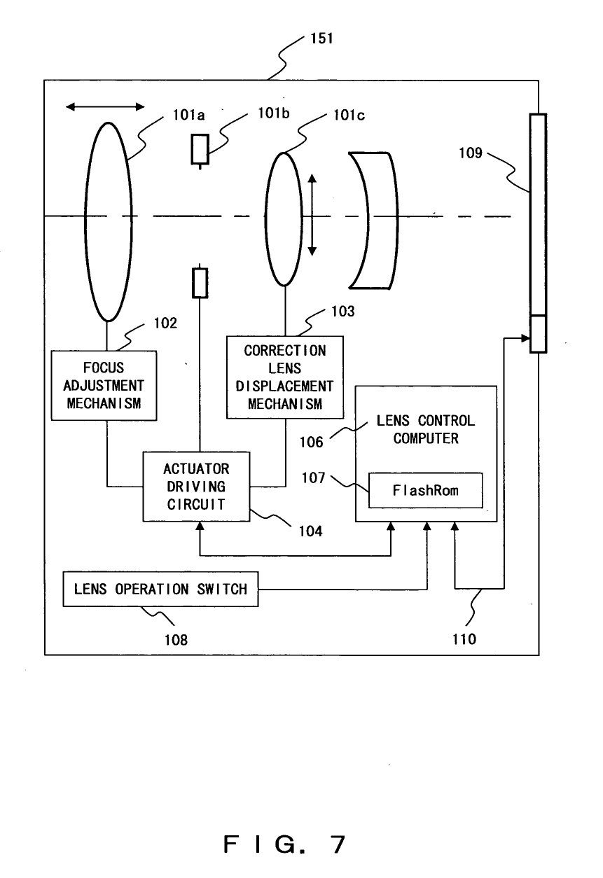

FIG. 7 is a schematic exemplifying a configuration of a taking lens 151 of L-0C type. The taking lens 151 shown in this figure is a taking lens comprising not a sensor but a correction mechanism. A difference from the taking lens 100 shown in FIG. 1 exists in a point that the angular speed sensor 105 is not comprised.

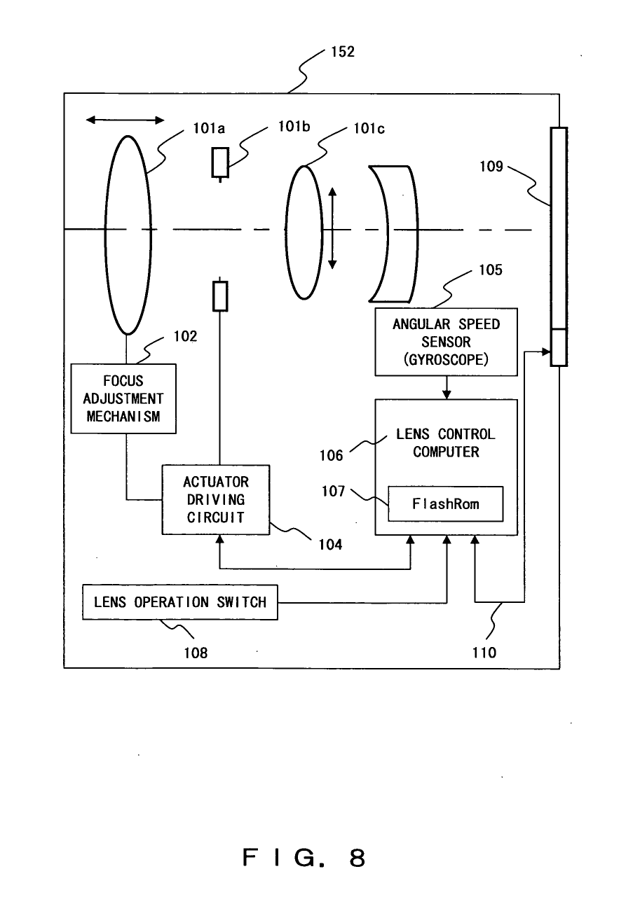

FIG. 8 is a schematic exemplifying a configuration of a taking lens 152 of L-S0 type. The taking lens 152 shown in this figure is a taking lens comprising not a correction mechanism but a sensor. A difference from the taking lens 100 shown in FIG. 1 exists in a point that the correction lens displacement mechanism 103 is not comprised.

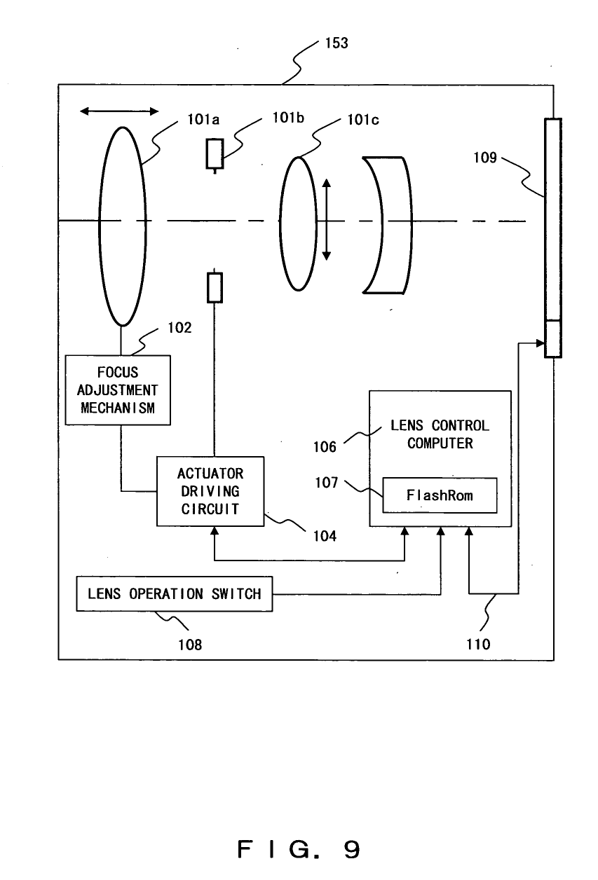

FIG. 9 is a schematic exemplifying a configuration of a taking lens 153 of L-00 type. The taking lens 153 shown in this figure is a taking lens comprising neither of a sensor and a correction mechanism. A difference from the taking lens 100 shown in FIG. 1 exists in a point that the correction lens displacement mechanism 103 and the angular speed sensor 105 are not comprised.

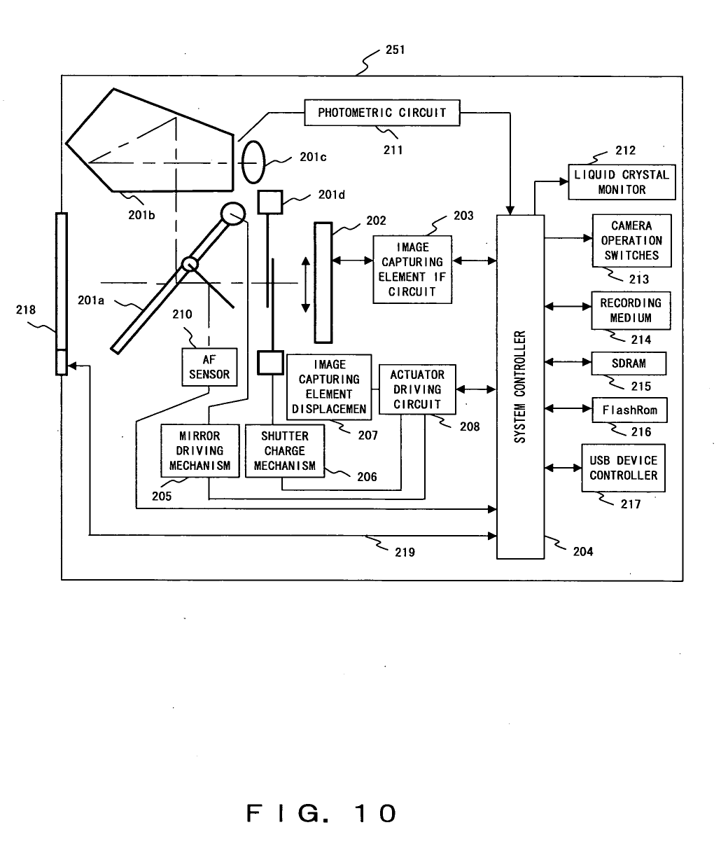

FIG. 10 is a schematic exemplifying a configuration of a camera body 251 of B-0C type. The camera body 251 shown in this figure is a camera body comprising not a sensor but a correction mechanism. A difference from the camera body 200 shown in FIG. 1 exists in a point that the angular speed sensor 209 is not comprised.

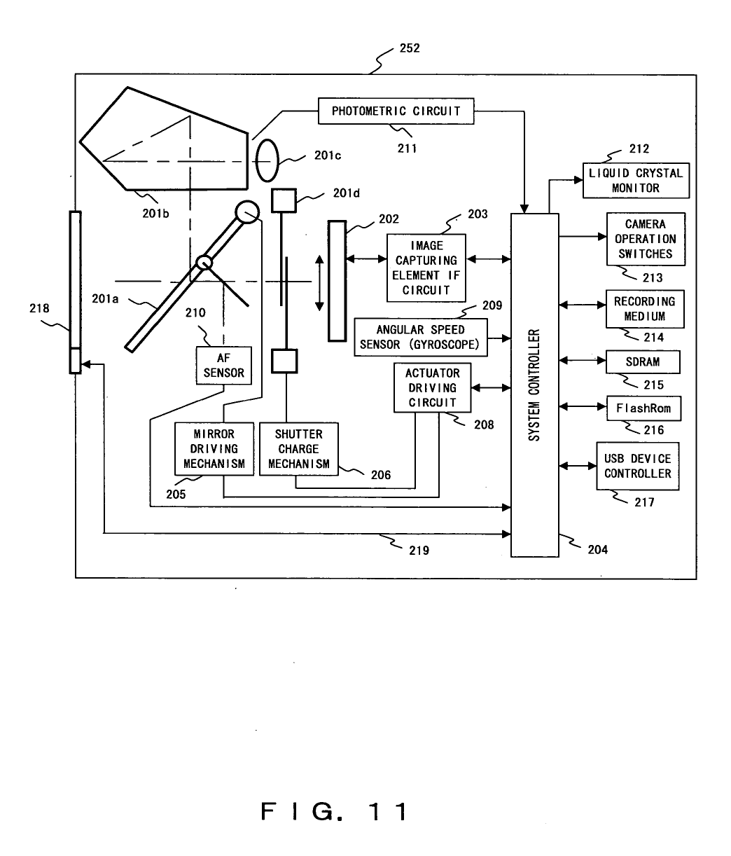

FIG. 11 is a schematic exemplifying a configuration of a camera body 252 of B-S0 type. The camera body 252 shown in this figure is a camera body comprising not a correction mechanism but a sensor. A difference from the camera body 200 shown in FIG. 1 exists in a point that the image capturing element displacement mechanism 207 is not comprised.

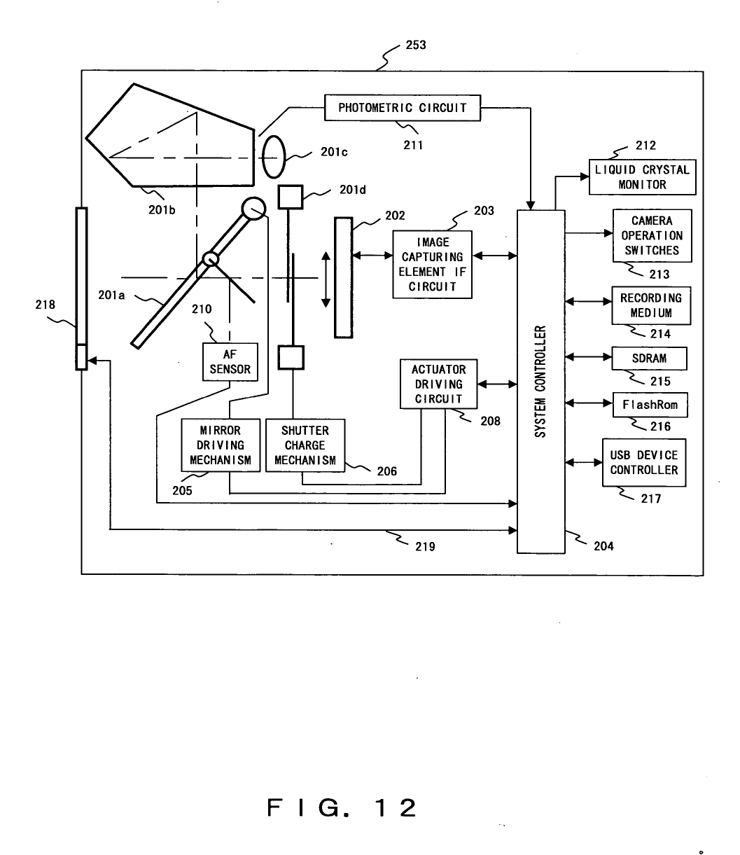

FIG. 12 is a schematic exemplifying a configuration of a camera body 253 of B-00 type. The camera body 253 shown in this figure is a camera body comprising neither of a sensor and a correction mechanism. A difference from the camera body 200 shown in FIG. 1 exists in a point that the image capturing element displacement mechanism 207 and the angular speed sensor 209 are not comprised.

In addition to the above described camera systems, namely, the camera systems configured with a taking lens and a camera body of the above described types, also a camera system where one or more converter lenses are arranged (linked) between a taking lens and a camera body exists.

Accordingly, if at least one sensor and one correction mechanism are provided in any of a taking lens, a converter lens and a camera body in the camera system configured with the taking lens, the converter lens and the camera body, the anti-shake function can be implemented.

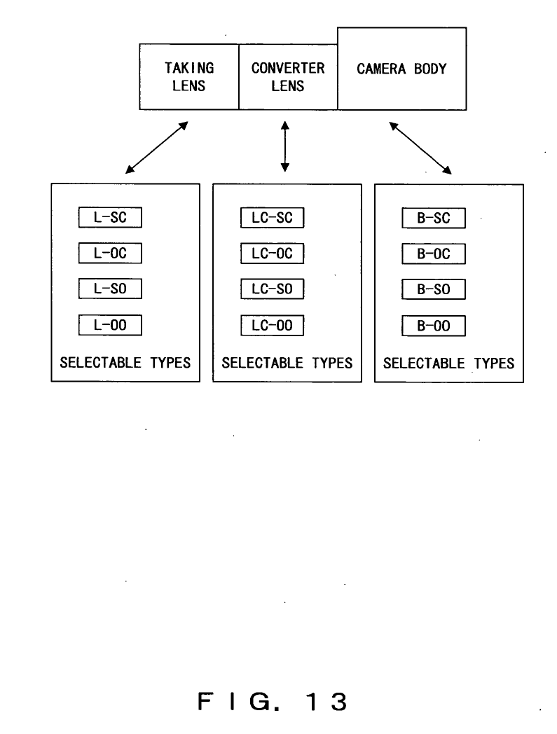

As shown in FIG. 13, as types of the taking lens, a taking lens L-SC comprising a sensor and a correction mechanism, a taking lens L-0C comprising not a sensor but a correction mechanism, a taking lens L-S0 comprising not a correction mechanism but a sensor, and a taking lens L-00 comprising neither of a sensor and a correction mechanism are considered.

Additionally, as types of the camera body, a camera body B-SC comprising a sensor and a correction mechanism, a camera body B-0C comprising not a sensor but a correction mechanism, a camera body B-S0 comprising not a correction mechanism but a sensor, and a camera body B-00 comprising neither of a sensor and a correction mechanism are considered.

Furthermore, as types of the converter lens, a converter lens LC-SC comprising a sensor and a correction mechanism, a converter lens LC-0C comprising not a sensor but a correction mechanism, a converter lens LC-S0 comprising not a correction mechanism but a sensor, and a converter lens LC-00 comprising neither of a sensor and a correction mechanism are considered.

LC, S, and C respectively mean Converter Lens, Sensor and Correction. Additionally, 0 means that a sensor or a correction mechanism is not comprised.

A camera system configured with a taking lens, a converter lens and a camera body of the above described types becomes a camera system that can implement the anti-shake function as long as at least one or more of S and C respectively exist in character strings indicating a configured type. Examples include a combination of L-00, LC-0C and B-S0, a combination of L-00, LC-0C and B-S0, etc.

Meanwhile, as a configuration of the camera system that can implement the anti-shake function, a system including a plurality of configurations, which can operate an anti-shake, exists. Examples include a combination of L-00, L-SC and B-0S, a combination of L-00, LC-0C and B-SC, etc.

With the camera system implemented with the combination of L-00, LC-SC and B-S0, both a sensor on the side of the lens converter and a sensor on the side of the camera body can be used to detect the amount of image shake.

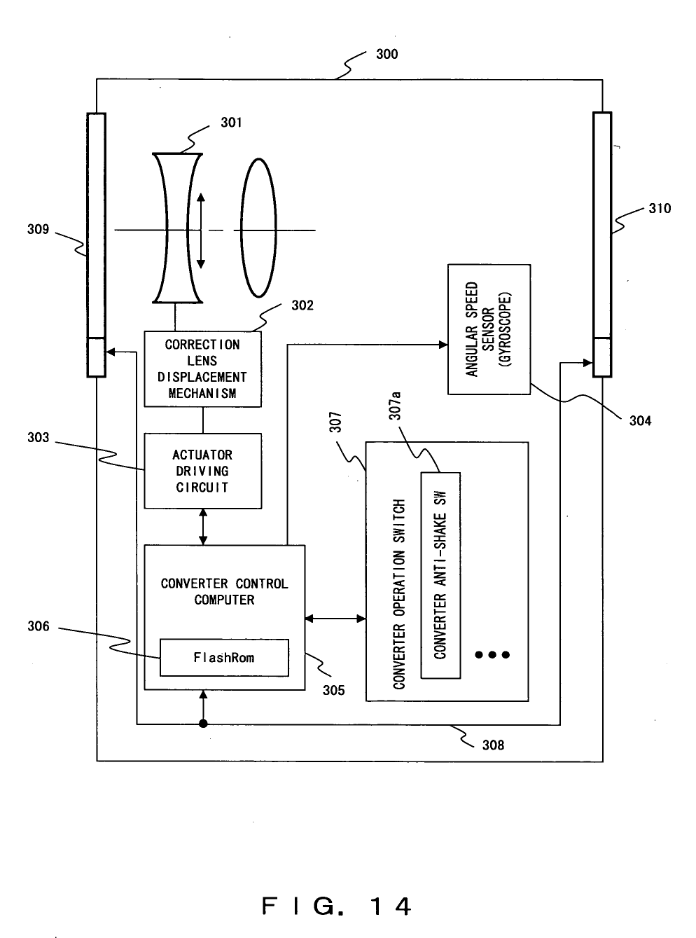

In this case, for example, a converter priority mode for operating the converter lens anti-shake by giving a higher priority to the setting of a converter lens anti-shake SW (for example, see FIG. 14) is provided as a mode that can be set with the mode setting SW 213c shown in FIG. 1 in addition to the lens priority mode for operating the lens anti-shake by giving a higher priority to the setting of the lens anti-shake SW 108a, and the body priority mode for operating the body anti-shake by giving a higher priority to the setting of the body anti-shake SW 213b.

Then, the process shown in FIG. 2 is performed, and any of the lens priority mode, the body priority mode and the converter priority mode is set as the anti-shake mode.

Then, for example, the system controller 204 may obtain the type of the taking lens (such as L-00) and the type of the converter lens (such as LC-SC), which are stored in the FlashRoms 107 and 306, by making a communication with the lens control computer 106 and the converter lens 300, may read the type of the camera body (such as B-S0), which is stored in the FlashRom 216, and may select an angular speed sensor according to the anti-shake mode.

Additionally, with a camera system implemented with the combination of L-00, LC-0C and B-SC, a correction lens displacement mechanism comprised by a converter lens, or the image capturing element displacement mechanism comprised by the camera body may be used for a correction operation for preventing an image from degrading according to the amount of image shake. A displacement mechanism to be used with higher priority may be made selectable as in the camera system shown in FIG. 1.

Also in this case, a converter priority mode for operating the converter lens anti-shake by giving a higher priority to the setting of the converter lens anti-shake SW (for example, see FIG. 14) is provided as a mode that can be set with the mode setting SW 213c shown in FIG. 1 in addition to the lens priority mode for operating the lens anti-shake by giving a higher priority to the setting of the lens anti-shake SW 108a, and the body priority mode for operating the body anti-shake by giving a higher priority to the setting of the body anti-shake SW 213b.

Then, the process shown in FIG. 2 is performed to set any of the lens priority mode, the body priority mode, and the converter priority mode as the anti-shake mode.

Next, for example, the system controller 204 may obtain the type of the taking lens (such as L-00) and the type of the converter lens (such as LC-0C), which are stored in the FlashRoms 107 and 306, by making a communication with the lens control computer 106 and the converter lens 300, may read the type of the camera body (such as B-SC), which is stored in the FlashRom 216, and may select and operate a displacement mechanism according to the anti-shake mode.

Specific configurations of the converter lenses LC-SC, LC-0C, LC-S0 and LC-00 are described below.

FIG. 14 is a schematic exemplifying a configuration of a converter 300 of LC-SC type.

The converter lens 300 shown in this figure comprises an optical system having at least a correction lens 301 for changing the optical axis of incident light, a correction lens displacement mechanism 302 for displacing the correction lens 301 on a plane vertical to the optical axis or for tilting the correction lens 301, an actuator driving circuit 303 for driving the correction lens displacement mechanism 302, an angular speed sensor 304 for detecting the shake (image shake) of the converter lens 300, a converter control computer 305 for performing an anti-shake operation according to an instruction from the camera body 200, a FlashRom 306 for storing a program for operating the converter control computer 305, and a converter operation switch 307, which is intended to switch between the validity and the invalidity of the anti-shake function.

In the above described configuration, the converter operation switch 307 includes at least a converter anti-shake SW 307a for instructing whether or not to operate the anti-shake operation of the converter lens 300.

The converter control computer 306 makes the actuator driving circuit 303 drive to operate the correction lens displacement mechanism 302 according to an instruction from the camera body 200.

Additionally, the converter control computer 306 calculates the amount of image shake by performing an integration process for an angular speed measured by the angular speed sensor 304, and makes the actuator driving circuit 303 drive to correct the amount of image shake. As a result, the correction lens 301 is displaced, and also the optical axis is displaced to correct the amount of image shake.

For example, the taking lens 100 and the converter lens 300 are connected to be attachable/detachable with an L mount 109 and a CB mount 309, so that the converter lens 300 and the camera body 200 are connected to be attachable/detachable with a CL mount 310 and a B mount 218. In consequence, the optical system comprised by the taking lens 100, the optical system comprised by the converter lens 300, and the optical system comprised by the camera body 200 are linked.

Additionally, a lens side communication line 110 comprised by the taking lens 100, and a converter side communication line 308 are connected via the L mount 109 and the CB mount 309, and the converter side communication line 308 and a body side communication line 219 are connected via the CL mount 310 and the B mount 218.

As a result, the lens control computer 106, the system controller 204 and the converter control computer 305 can communicate with one another.

Also the converter control computer 305 comprises a communication unit for making a communication with a device electrically connected, although this is not shown. A communication is made among the communication units of the lens control computer 106, the system controller 204 and the converter control computer 305, whereby a communication among the lens control computer 106, the system controller 204 and the converter control computer 305 can be made.

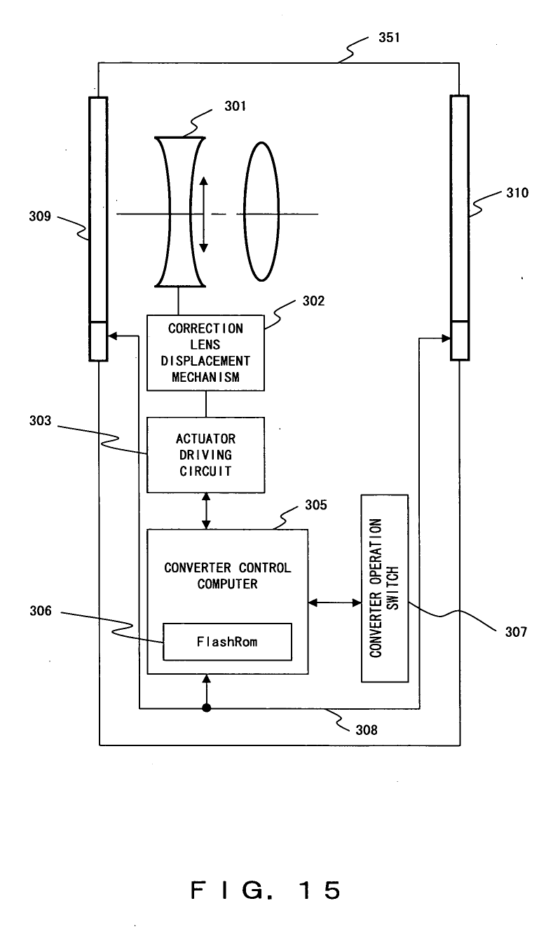

FIG. 15 is a schematic exemplifying a configuration of a converter lens 351 of LC-0C type. The converter lens 351 shown in this figure is a converter lens comprising not a sensor but a correction mechanism. A difference from the converter lens 300 shown in FIG. 14 exists in a point that the angular speed sensor 304 is not comprised.

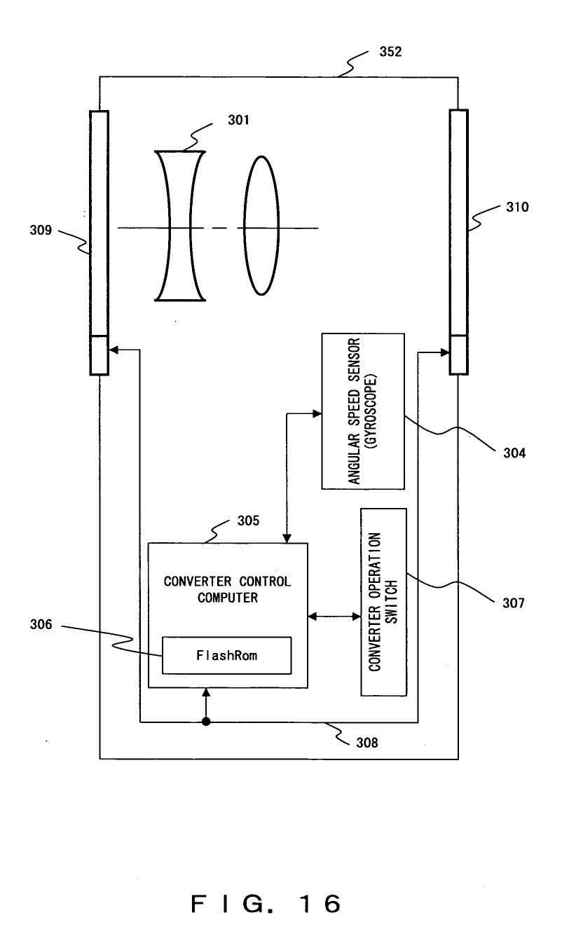

FIG. 16 is a schematic exemplifying a configuration of a converter lens 352 of LC-S0 type. The converter lens 352 shown in this figure is a converter lens comprising not a correction mechanism but a sensor. A difference from the converter lens 300 shown in FIG. 14 exists in a point that the correction lens displacement mechanism 302 and the actuator driving circuit 303 are not comprised.

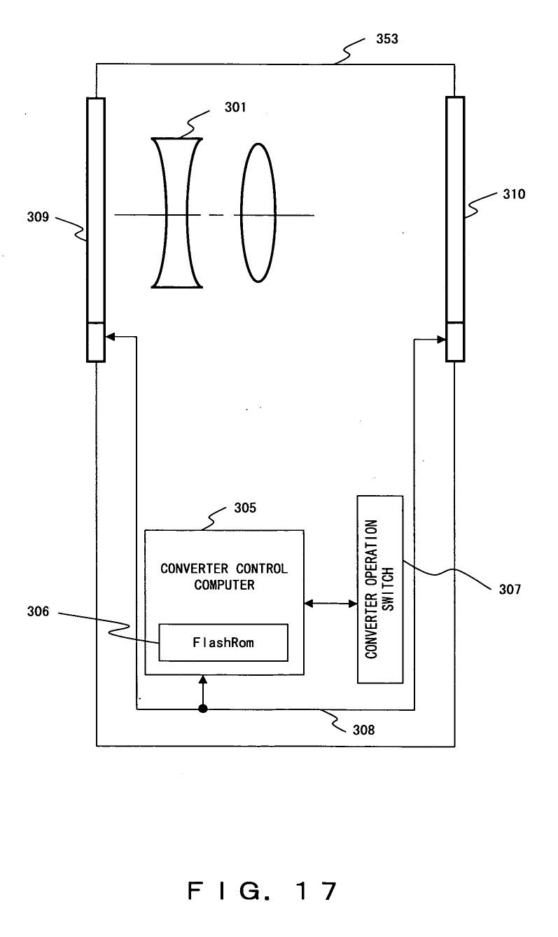

FIG. 17 is a schematic exemplifying a configuration of a converter lens 353 of LC-00 type. The converter lens 353 shown in this figure is a converter lens comprising neither of a sensor and a correction mechanism. A difference from the converter lens 300 shown in FIG. 14 exists in a point that the correction lens displacement mechanism 302, the actuator driving circuit 303 and the angular speed sensor 304 are not comprised.

If a camera system including a converter lens is implemented as described above, the lens operation suspension instruction described with reference to FIG. 3 may be communicated (transmitted) to both the taking lens and the converter lens, and both or a specified one of the operations of the taking lens and the converter lens may be suspended according to the lens operation suspension instruction.

As described above, in a camera system configured with a camera body and a taking lens, or with a camera body, a taking lens and a converter lens, a plurality of sensors for detecting the amount of image shake are sometimes included. Or, a plurality of correction mechanisms are sometimes included. A sensor and a correction mechanism, which are to be used with higher priority, are configured to be selectable by a user also in such a case, whereby an anti-shake function according to user intention can be executed.

### (2) Second Preferred Embodiment

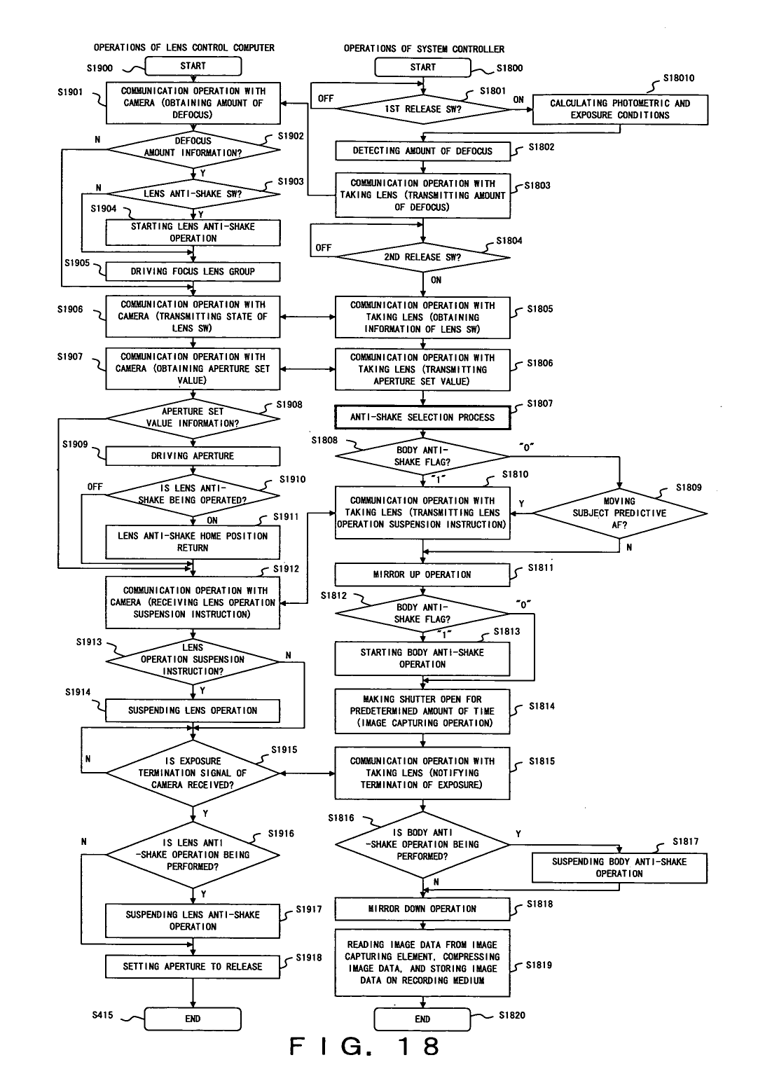

FIG. 18 is a flowchart showing the shooting operation of a camera system according to the second preferred embodiment. An anti-shake operation of the camera system according to the second preferred embodiment is described below with reference to this flowchart.

When a camera operation switch 213 is operated, for example, an interrupt signal is input to a system controller 204, and an MPU comprised by the system controller 204 executes a program stored at a predetermined address within a FlashRom 216 according to the interrupt signal, so that the shooting operation, etc. are started (step S1800).

The process described below is implemented in a way such that the MPUs respectively comprised by the lens control computer 106 and the system controller 204, which are shown in FIG. 1, execute instructions written in a predetermined program. However, for ease of explanation, the process is described by assuming the lens control computer 106 and the system controller 204 to be the main entities of the process.

When the shooting operation is started, the system controller 204 checks whether or not a 1st release SW is turned on with a release SW 213a. If the 1st release SW is not in ON state (OFF state), the system controller 204 repeats the process of step S1801 until the 1st release SW is turned on.

When the 1st release SW is turned on in step S1801, the system controller 204 advances the process to step S18010. Then, the system controller 204 calculates exposure conditions (an aperture set value and a shutter time) from the output value of the photometric circuit 211. In step S1802, the system controller 204 calculates the amount of defocus from the output value of the AF sensor 210.

Upon completion of the calculation of the amount of defocus, etc., the system controller 204 advances the process to step S1803. Then, the system controller 204 notifies the lens control computer 106 of the amount of defocus (predetermined control information) calculated in step S1802 by making a communication with the lens control computer 106 comprised by the taking lens 100.

At this time, even if the amount of defocus is 0, the system controller 204 transmits the amount of defocus 0 to the lens control computer 106. Additionally, even if the MN/AFSW 108c is set to manual focus, the system controller 204 transmits the amount of defocus 0.

In this preferred embodiment, the anti-shake operation performed by the lens control computer 106 is permitted also at timing other than the exposure operation of the camera. In a preferred embodiment described below, the anti-shake operation on the lens side can be performed also at timing from when the 1st release SW is turned on until when the 2nd release SW is turned on. With a single-lens reflex camera, a subject image can be observed through a finder. It is convenient to a user that the subject image can be observed without being shaken at this time. To perform this operation, the lens control computer 106 must detect that the 1st release SW is turned on. Communication data of the amount of defocus is transmitted in response to the 1st release SW. Accordingly, by receiving the communication data of the amount of defocus, it can be detected that the 1st release SW is turned on. Note that, however, it is a prerequisite to surely communicate the amount of defocus when the 1st release SW is turned on. Accordingly, even if the amount of defocus is 0 or manual focus is set, a communication is made. In this preferred embodiment, the communication of the amount of defocus is used. However, any communication may be available if it is made according to the operation of the 1st release SW.

In the meantime, in step S1901, the lens control computer 106 obtains predetermined data by making a communication with the system controller 204. After obtaining the predetermined data, the lens control computer 106 advances the process to step S1902.

In step S1902, the lens control computer 106 determines whether or not the obtained predetermined data is the amount of defocus. If the predetermined data is not the amount of defocus, the lens control computer 106 advances the process to step S1906. Or, if the predetermined data is the amount of defocus, the lens. control computer 106 advances the process to step S1903.

In step S1903, the lens control computer 106 obtains the state of the lens anti-shake SW 108a. If the lens anti-shake SW 108a is in ON state, the lens control computer 106 advances the process to step S1904 to start the lens anti-shake operation (changes the operation state).

Or, if the lens anti-shake SW 108a is in OFF state, the lens control computer 106 advances the process to step S1905. Then, the lens control computer 106 makes the actuator driving circuit 104 drive to adjust the position of the focus lens 101a according to the obtained amount of defocus.

Upon completion of the transmission of the amount of defocus in step S1803, the system controller 204 advances the process to step S1804.

Then, the system controller 204 checks whether or not the 2nd release SW is turned on with the release SW 213a. If the 2nd release SW is not turned on (in OFF state), the system controller 204 repeats the process of step S1804 until the 2nd release SW is turned on.

When the 2nd release SW is turned on in step S1804, the system controller 204 advances the process to step S1805. Then, the system controller 204 obtains the setting information of the lens operation switches 108 by making a communication with the lens control computer 106 of the taking lens 100.

In the meantime, in step S1906, the lens control computer 106 reads the setting information of the lens operation switches 108 by request of the setting information of the lens operation switches 108, which is made from the system controller 204, and transmits the read information to the system controller 204.

After obtaining the setting information of the lens operation switches 108 from the lens control computer 106 in step S1805, the system controller 204 advances the process to step S1806. Then, the system controller 204 transmits the aperture set value (predetermined control information), which is calculated in step S1802, to the lens control computer 106.

Here, the system controller 204 transmits the aperture set value to the lens control computer 106 even if a change is not made to the aperture set value or the aperture set value is 0.

In the meantime, in step S1907, the lens control computer 106 obtains the predetermined data by making a communication with the system controller 204. After obtaining the predetermined data, the lens control computer 106 advances the process to step S1908.

In step S1908, the lens control computer 106 determines whether or not the obtained predetermined data is the aperture set value. If the predetermined data is not the aperture set value, the lens control computer 106 advances the process to step S1912. Or, if the predetermined data is the aperture set value, the lens control computer 106 advances the process to step S1909. Then, the lens control computer 106 makes the actuator driving circuit 104 drive to adjust the aperture 101b according to the aperture set value.

Upon termination of the adjustment of the aperture 101b, the lens control computer 106 advances the process to step S1910 to determine whether or not the lens anti-shake operation is being performed. If the lens anti-shake operation is being performed, the lens control computer 106 advances the process to step S1911 to suspend the lens anti-shake operation (change the operation state), and moves the correction lens 101c to a predetermined position (performs a home position return operation. This operation sets the correction lens to the central position of a movable range of the correction lens).

Upon completion of the transmission of the aperture set value to the lens control computer 106 in step S1806, the system controller 204 advances the process to step S1807 to perform the anti-shake selection process for selecting which of the lens anti-shake function and the body anti-shake function to use.

In step S1807, the system controller 204 performs the anti-shake selection process based on the setting information of the lens anti-shake SW 108a, which is obtained in step S1805, the setting information of the body anti-shake SW 213b, and the anti-shake mode described with reference to FIG. 2. If the body anti-shake is used, the system controller 204 sets the body anti-shake flag to 1.

Or, if the lens anti-shake is used, the system controller 204 clears the body anti-shake flag to 0 in step S1807, and advances the process to step S1808.

In this preferred embodiment, if the body anti-shake flag is 0, this means that the body anti-shake is not used. Or, if the body anti-shake flag is 1, this means that the body anti-shake is used. Details of the anti-shake selection process are omitted because they are described with reference to FIGS. 4 and 5.

In step S1808, the system controller 204 determines the value of the body anti-shake flag. If the body anti-shake flag is 0, the system controller 204 advances the process to step S1809. Or, if the body anti-shake flag is 1, the system controller 204 advances the process to step S1810.

In step S1809, the system controller 204 determines based on the state of the AF mode setting SW 213d whether or not a set AF mode is the moving subject predictive AF mode. If the set AF mode is the moving subject predictive AF mode, the system controller 204 advances the process to step S1810. Otherwise, the system controller 204 advances the process to step S1811.

In step S1810, the system controller 204 transmits the lens operation suspension instruction to the lens control computer 106. Upon completion of the transmission, the system controller 204 advances the process to step S1811.

In the meantime, the lens control computer 106 advances the process to step S1913 upon receipt of the lens operation suspension instruction from the system controller 204 in step S1912.

In step S1913, the lens control computer 106 determines whether or not the received instruction is the lens operation suspension instruction. If the received instruction is the lens operation suspension instruction, the lens control computer 106 advances the process to step S1914. Otherwise, the lens control computer 106 advances the process to step S1915.

In step S1914, the lens control computer 106 suspends the operations within the taking lens 100, such as the focus driving, the lens anti-shake operation, etc., within the operation suspension time (such as 50 ms), which is included in the lens operation suspension instruction. Then, the lens control computer 106 advances the process to step S1915.

In step S1811, the system controller 204 makes the mirror driving mechanism 205 drive to perform a mirror UP operation for moving the quick return mirror 201a in the direction of a so that incident light is input to the image capturing element.

Upon completion of the mirror UP operation of the quick return mirror 201a, the system controller 204 advances the process to step S1812.

In step S1812, the system controller 204 determines the value of the body anti-shake flag. If the value of the body anti-shake flag is 0, the system controller 204 advances the process to step S1814. Or, if the value is 1, the system controller 204 advances the process to step S1813.

The system controller 204 then starts the body anti-shake operation in step S1813, and advances the process to step S1814.

In step S1814, the system controller 204 opens the shutter 201d by making the actuator driving circuit 208 drive, and starts image capturing.

After a predetermined amount of time elapses, the system controller 204 advances the process to step S1815 to again close the shutter 201d, and notifies the lens control computer 106 of the termination of exposure.

In the meantime, the lens control computer 106 advances the process to step S1916 when the termination of exposure is notified from the system controller 204 in step S1915. If the lens anti-shake operation is being performed, the system controller 204 advances the process to step S1917 to suspend the lens anti-shake operation.

If the lens anti-shake operation is not being performed or if the suspension of the lens anti-shake operation is complete in step S1916, the lens control computer 106 advances the process to step S1918.

In step S1918, the lens control computer 106 makes the actuator driving circuit 104 drive to release the aperture 101b, and terminates the process (step S1919).

Upon termination of exposure in step S1815, the system controller 204 advances the process to step S1816. If the body anti-shake operation is being performed, the system controller 204 advances the process to step S1817 to suspend the body anti-shake operation.

If the body anti-shake operation is not being performed in step S1816 or if the suspension of the body anti-shake operation is complete in step S1817, the system controller 204 advances the process to step S1818. Then, the system controller 204 makes the actuator driving circuit 208 drive to perform a mirror DOWN operation for moving the quick return mirror 201a in the direction of b so that incident light is input to the pentaprism by being reflected on the quick return mirror 201a.

Upon completion of the mirror DOWN operation, the system controller 204 advances the process to step S1819. Then, the system controller 204 reads image data from the image capturing element 202 via the image capturing element IF circuit 203, compresses the image data, and stores the image data on the recording medium 214. Then, the system controller 204 terminates the process (step S1820).

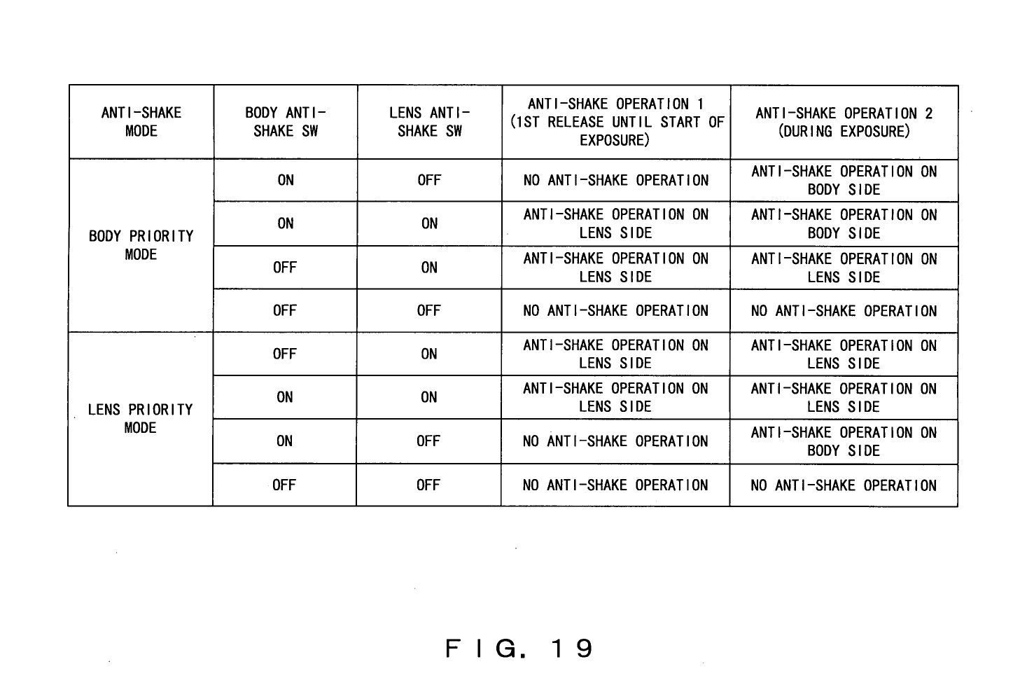

Anti-shake operations performed by the above described process are shown in FIG. 19. This figure is a schematic for explaining the anti-shake operations performed by the anti-shake selection process according to the second preferred embodiment.

An anti-shake operation table shown in FIG. 19 represents a relationship among an anti-shake mode, the body anti-shake SW 213b, the lens anti-shake SW 108a, and an anti-shake operation. An anti-shake operation 1 shown in FIG. 19 indicates an anti-shake operation from the 1st release with the release SW 213a until the start of exposure. An anti-shake operation 2 indicates an anti-shake operation during exposure.

If the anti-shake mode is the body priority mode, and if the lens anti-shake SW 108a is in ON state, the lens anti-shake is operated from the 1st release until the start of exposure regardless of whether the body anti-shake SW 213b is in either ON or OFF state. Or, if the lens anti-shake SW 108a is in OFF state, the lens anti-shake operation is not performed.

Additionally, during the exposure, the body anti-shake operation is performed regardless of whether the lens anti-shake SW 108a is in either ON or OFF state, if the body anti-shake SW 213b is in ON state. Or, if the body anti-shake SW 213b is in OFF state, and if the lens anti-shake SW 108a is in ON state, the lens anti-shake is operated. If both the body anti-shake SW 213b and the lens anti-shake SW 108a are in OFF state, the anti-shake operation is not performed.

Also if the anti-shake mode is the lens priority mode, and if the lens anti-shake SW 108a is in ON state, the lens anti-shake is operated from the 1st release until the start of exposure regardless of whether the body anti-shake SW 213b is in either ON or OFF state. If the lens anti-shake SW 108a is in OFF state, the lens anti-shake is not operated.

During the exposure, the lens anti-shake is operated regardless of whether the body anti-shake SW 213b is in either ON or OFF state, if the lens anti-shake SW 108a is in ON state. Or, if the lens anti-shake SW 108a is in OFF state, and if the body anti-shake SW 213b is in ON state, the body anti-shake is operated. Or, if both the lens anti-shake SW 108a and the body anti-shake SW 213b are in OFF state, the anti-shake operation is not performed.

In this preferred embodiment, the anti-shake function of the camera body 200 is implemented as a function operating only during exposure. However, the anti-shake operation may be started prior to the start of exposure, for example, after the 1st release SW is turned on. Then, the quick return mirror may be raised up, the shutter 201a may be once opened, and the output of the image capturing element 202 may be displayed on the liquid crystal monitor 212 of the camera body 200 as a live image. As a result, a user can view the unshakable subject image on the monitor.

In this case, if the body anti-shake is selected, the lens operation suspension instruction is transmitted simultaneously with the start of the body anti-shake operation, for example, immediately after the 1st release SW is turned on, so that the lens anti-shake operation can be suspended even before the 2nd release SW is turned on.

As described above, control information, such as the amount of defocus, the amount of aperture, etc., which is required to control the taking lens 100, is used to control the anti-shake operation of the taking lens 100, thereby producing an effect that a communication between the taking lens 100 and the camera body 200 can be implemented without making the communication complicated.

Additionally, since the control information required to control the taking lens 100 is used to control the anti-shake operation of the taking lens 100, the anti-shake operation of the taking lens 100 can be controlled without adding a new communication process. This produces an effect that a delay of an operation start (release time lag), which is caused by adding a new communication process, such as a delay from when the release SW 213a is operated until when the anti-shake operation or exposure actually starts, can be prevented.

Furthermore, with the process of the camera system according to this preferred embodiment, which is shown in FIG. 18, the lens anti-shake operation is started upon detection of the ON state of the 1st release SW. Therefore, the influence of image shake can be removed from a subject image, which is observed through the finder composed of, for example, the pentaprism 201b and the eyepiece lens 201c. This produces an effect that more stable shooting (such as framing) can be made.

### (3) Third Preferred Embodiment

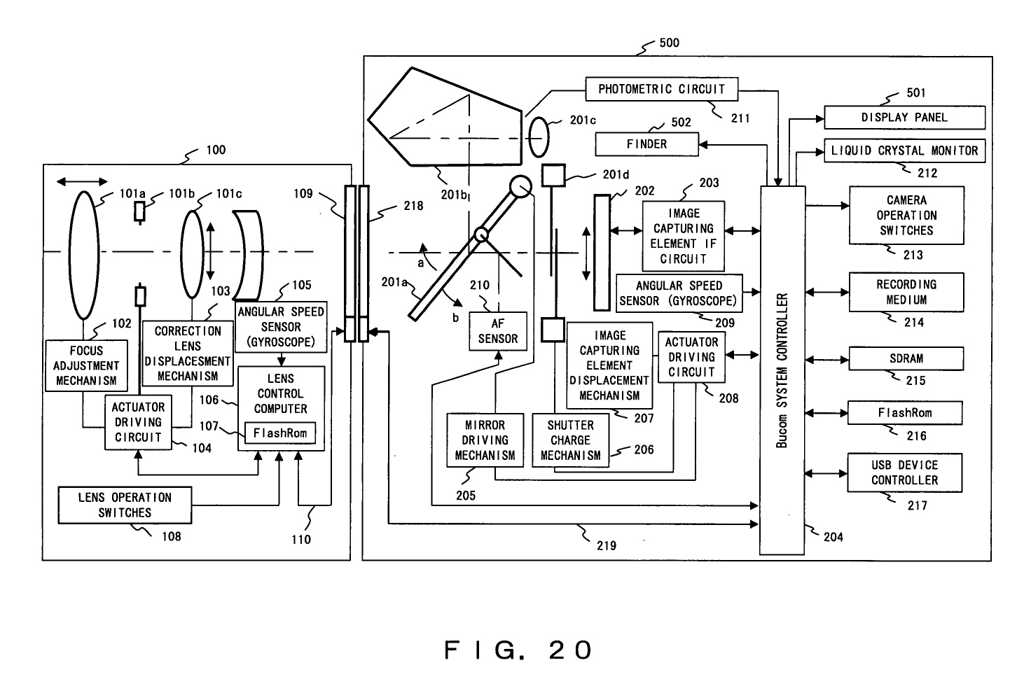

FIG. 20 is a schematic showing the entire configuration of a camera system according to the third preferred embodiment.

The camera system shown in FIG. 20 is configured with a taking lens 100 and a camera body 500, which are connected to be mutually attachable/detachable.

The taking lens 100 is the taking lens described with reference to FIG. 1. The camera body 500 is a camera body configured by further providing, in the camera body 200 described with reference to FIG. 1, a display panel 501 for displaying various items of shooting information, and a finder display unit 502 for displaying the shooting information within the finder.

On the display panel 501, a photometric mode, an AF mode, an image quality mode, a shutter speed, an aperture value, a battery remaining amount, the number of pictures that can be taken, color space setting, continuous shooting setting, etc. are displayed in addition to the display of the anti-shake functions of the taking lens 100 and the camera body 500 (hereinafter referred to as an anti-shake display 506). Also on the finder display unit 502 and the liquid crystal monitor 212, the anti-shake display 506 is made. This figure shows the case where all of segments for the anti-shake display are toggled on.

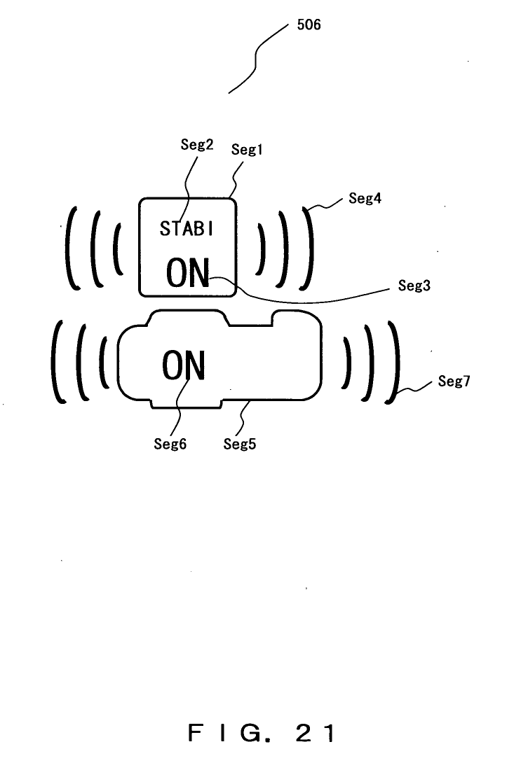

FIG. 21 is a schematic showing a specific example of the anti-shake display 506 according to the third preferred embodiment.

The anti-shake display 506 shown in this figure is configured with a segment Seg1 representing a state where the taking lens 100 is attached to the camera body 200, a segment Seg2 representing that the taking lens 100 has the anti-shake function, a segment Seg3 representing that the lens anti-shake SW 108a of the taking lens 100 is in ON state, a segment Seg4 representing that the lens anti-shake is being operated, a segment Seg5 representing the camera body 200, a segment Seg6 representing that the body anti-shake SW 213b of the camera body 200 is in ON state, and a segment Seg7 representing that the body anti-shake is being operated.

A process for the above described anti-shake display 506 is shown in FIG. 22. This figure is a flowchart showing the process for the anti-shake display 506.

For example, if the taking lens 100 and the camera body 200 are attached/detached or if a lens operation switch 108 or a camera operation switch 213 is operated, an interrupt signal according to the operation is transmitted to the system controller 204, and the anti-shake display data 220 stored in the FlashRom 216 is updated by a predetermined program. Then, the display process based on the anti-shake display data 220 is started (step S2200).

Here, the anti-shake display data 220 shown in FIG. 22 includes the attachment state of the taking lens 100, anti-shake correspondence information indicating whether or not the attached taking lens 100 comprises the anti-shake function, lens anti-shake SW information indicating the ON/OFF state of the lens anti-shake SW 108a, lens anti-shake operation information indicating the operation state of the lens anti-shake (whether or not the operation is being performed), body anti-shake SW information indicating the ON/OFF state of the body anti-shake SW 213b, and body anti-shake operation information indicating the operation state of the body anti-shake (whether or not the operation is being performed).

In step S2201, the system controller 204 reads the anti-shake display data 220 from a predetermined address, for example, of the FlashRom 216, and advances the process to step S2202.

In the display process described below, a display target is the liquid crystal monitor 212, the display panel 501 or the finder 502. If the display is made on whichever of them, a display having the same form of the anti-shake display 506 shown in FIG. 21 is made.

In step S2202, the system controller 204 toggles on the display of Seg5 representing the camera body 500 on the liquid crystal monitor 212, the display panel 501 and the finder 502 depending on need.

Furthermore, the system controller 204 displays the attachment state of the taking lens 100. For example, the system controller 204 references the attachment information of the anti-shake display data 220, and toggles on the display of Seg1, which represents that the lens is attached, if the taking lens is attached. Or, if the taking lens is not attached, the system controller 204 toggles off (or does not make) the display of Seg1.

Additionally, if the taking lens 100 is attached, the system controller 204 references the anti-shake correspondence information of the anti-shake display data 220. If the taking lens 100 has the anti-shake function, the system controller 24 toggles on the display of Seg2, which represents that the anti-shake function is comprised. Or, if the anti-shake function is not comprised, the system controller 204 toggles off (or does not make) the display of Seg2.

After displaying the attachment state of the taking lens 100 in step S2202, the system controller 204 advances the process to step S2203. Then, the system controller 204 displays the states of the lens anti-shake SW 108a and the body anti-shake SW 213b.

For example, the system controller 204 references the lens anti-shake SW information of the anti-shake display data 220. If the switch is in ON state, the system controller 204 toggles on the display of Seg3. Or, if the switch is not in ON state (OFF state), the system controller 204 toggles off (or does not make) the display of Seg3.

Similarly, the system controller 204 references the body anti-shake SW information of the anti-shake display data 220. If the switch is in ON state, the system controller 204 toggles on the display of Seg6. Or, if the switch is not in ON state (OFF state), the system controller 204 toggles off (or does not make) the display of Seg6.

Upon completion of the state display of the anti-shake SW in step S2203, the system controller 204 advances the process to step S2204. Then, the system controller 204 displays the states of the lens anti-shake operation and the body anti-shake operation.

For example, the system controller 204 references the lens anti-shake operation information of the anti-shake display data 220. If the lens anti-shake is being operated, the system controller 204 toggles on the display of Seg4. Or, if the lens anti-shake is not being operated, the system controller 204 toggles off (or does not make) the display of Seg4.

Furthermore, the system controller 204 references the body anti-shake operation information of the anti-shake display data 220. If the body anti-shake is being operated, the system controller 204 toggles on the display of Seg7. Or, if the body anti-shake is not being operated, the system controller 204 toggles off (or does not make) the display of Seg7.

Upon completion of the above described process, the system controller 204 terminates the display process (step S2205).

The above provided description refers to the anti-shake display process performed when the system controller 204 updates the contents of the anti-shake display data 220 according to an interrupt signal from a lens operation switch 108, etc. However, for example, also a case where the contents of the anti-shake display data 220 are updated with the process shown in FIG. 2, 3 or 5 is similar.

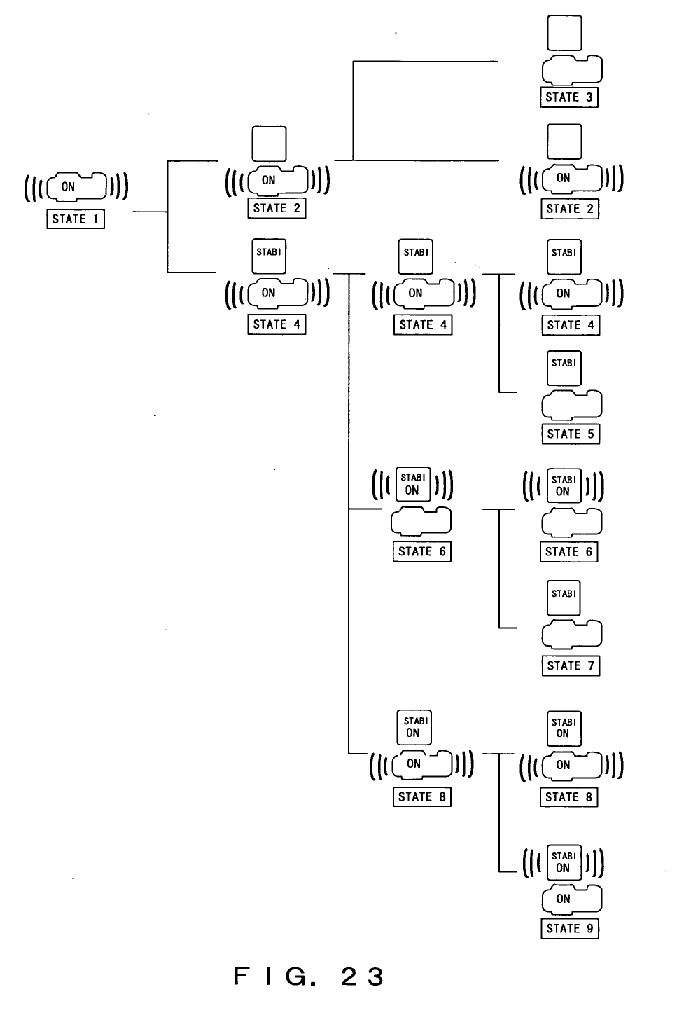

FIG. 23 is a schematic exemplifying a transition of the state of the anti-shake display 506 according to the third preferred embodiment.

A state 1 is a state where the display of Seg5 to Seg7 is toggled on. Since the display of Seg6 is toggled on, the body anti-shake SW is proved to be in ON state. Additionally, since the display of Seg7 is toggled on, the body anti-shake is proved to be being operated.

If the taking lens without the anti-shake function is attached in the state 1, the display of Seg1 is toggled on as indicated by a state 2. If the body anti-shake SW 213b is turned off in the state 2, the display of Seg6 and Seg7 is toggled off, and a transition is made to a state 3.

Namely, the state 2 represents a state where the taking lens does not comprise the anti-shake function, the body anti-shake SW 213b is in ON state, and the anti-shake function of the camera body is being operated. Additionally, the state 3 represents a state where the taking lens does not comprise the anti-shake function, and the anti-shake function of the camera body is not being operated.

If the taking lens comprising the anti-shake function is attached in the state 1, the display of Seg2 is toggled on as indicated by a state 4, and a transition is made to the state 4. Furthermore, if the body anti-shake SW 213b is turned off in the state 4, the display of Seg6 and Seg7 is toggled off, and a transition is made to a state 5.

Namely, the state 4 represents a state where the taking lens comprising the anti-shake function is attached, the body anti-shake SW 213b is in ON state, and the anti-shake function of the camera body is being operated. Additionally, the state 5 represents a state where the taking lens comprising the anti-shake function is attached, and the anti-shake functions of the taking lens and the camera body are not being operated.

If the body anti-shake SW 213b is turned off and the lens anti-shake SW 108a is turned on in the state 4, the display of Seg6 and Seg7 is toggled off and the display of Seg3 and Seg4 is toggled on. Then, a transition is made to a state 6. Furthermore, if the lens anti-shake SW 108a is turned off in the state 6, the display of Seg3 and Seg4 is toggled off, and a transition is made to a state 7.

Namely, the state 6 represents a state where the taking lens comprising the anti-shake function is attached, the lens anti-shake SW 108a is in ON state, and the anti-shake function of the taking lens is being operated. Additionally, the state 7 represents a state where the taking lens comprising the anti-shake function is attached, and the anti-shake functions of the taking lens and the camera body are not being operated.

If the lens anti-shake SW 108a is turned on in the state 4, the display of Seg3 is toggled on and a transition is made to a state 8. Here, if the mode setting SW 213c is set to the body priority mode, the state 8 is held. Or, if the mode setting SW 213c is set to the lens priority mode, the display of Seg7 is toggled off, the display of Seg4 is toggled on, and a transition is made to a state 9.

Namely, the state 8 represents a state where the taking lens comprising the anti-shake function is attached, the lens anti-shake SW 108a and the body anti-shake SW 213b are in ON state, and the anti-shake function of the camera body is being operated. Additionally, the state 9 represents a state where the taking lens comprising the anti-shake function is attached, the lens anti-shake SW 108a and the body anti-shake SW 213b are in ON state, and the anti-shake function of the taking lens is being operated.

Cases where the above described anti-shake display 506 is made on the liquid crystal monitor 212, the display panel 501 and the finder 502 are exemplified below.

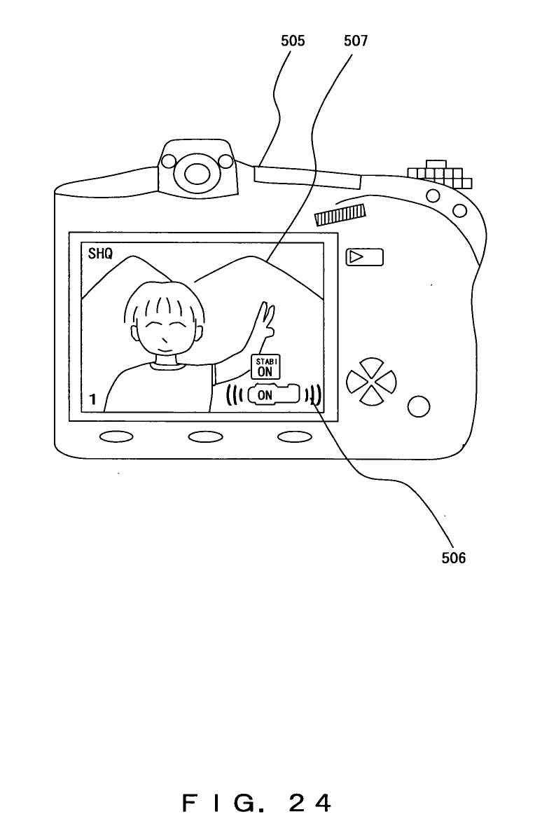

FIG. 24 is a schematic exemplifying the case where the anti-shake display 506 is made on the liquid crystal monitor 212 (on screen display) together with an image. The liquid crystal monitor 212 shown in FIG. 24 represents a rear display monitor arranged on the rear of a single-lens reflex camera.

The display of FIG. 24 is an example of a state where a shot image 507 is displayed with a replay button. The anti-shake display 506 is made at the lower right of the liquid crystal monitor 212. With the anti-shake display 506, the image 507, which is being replayed on the liquid crystal monitor 212, is proved to be shot not with the anti-shake function comprised by the taking lens but with the anti-shake function comprised by the camera body.

A process for making the anti-shake display 506 on the liquid crystal monitor 212 is the same as the process shown in FIG. 22. However, anti-shake display data 220 corresponding to the image 507 stored in the header of Exif data is used as the anti-shake display data 220.

Additionally, FIG. 24 shows the example of the anti-shake display 506 when the image is being replayed. However, the anti-shake display 506 can be made on the liquid crystal monitor 212 with the process shown in FIG. 22 also at the time of shooting, as a matter of course.

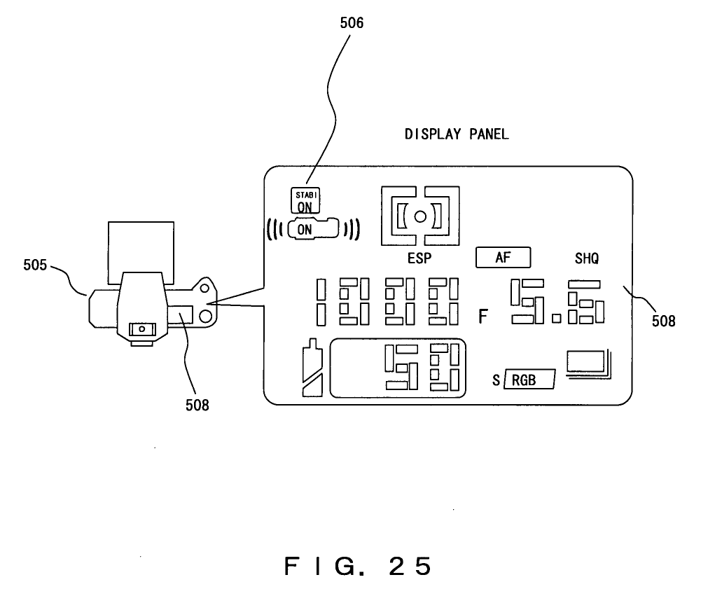

FIG. 25 is a schematic exemplifying the case where the anti-shake display 506 is made on the display panel 501. The display panel 501 shown in FIG. 25 is an example of an external LCD 508 arranged on the top of a single-lens reflex camera. On the external LCD 508, a photometric mode, an AF mode, an image quality mode, a shutter speed, an aperture value, a battery remaining amount, the number of pictures that can be taken, color space setting, continuous shooting setting and the like are displayed in addition to the anti-shake display 506 displayed at the upper left of the screen.

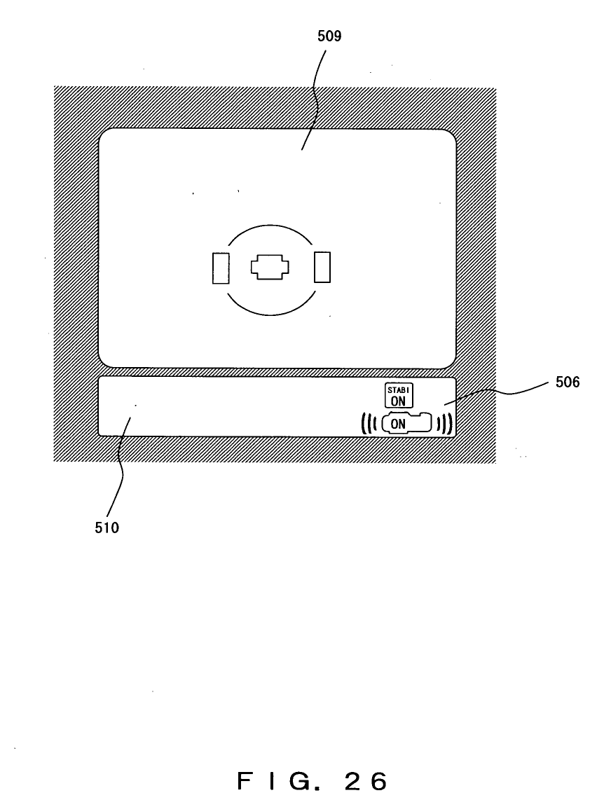

FIG. 26 is a schematic exemplifying the case where the anti-shake display 506 is made on the finder 502.

The finder 502 shown in FIG. 26 is configured with a view field frame 509 for observing a subject via the optical systems of the taking lens 100 and the camera body 500, and a liquid crystal display unit 510 for displaying a shutter speed, exposure, etc. The anti-shake display 506 is made at the right bottom of the liquid crystal display unit 510.

As described above, with the camera system according to this preferred embodiment, the segment Seg4 or Seg7 is displayed on the liquid crystal monitor 212, the display panel 501 and the finder 502 according to the lens anti-shake operation information and the body anti-shake operation information of the anti-shake display data 220, thereby producing an effect that a user can easily recognize which of the anti-shake functions respectively comprised by the taking lens 100 and the camera body 500 is being operated.

Additionally, the segments Seg3 and Seg6 are displayed on the liquid crystal monitor 212, the display panel 501 and the finder 502 according to the lens anti-shake SW information and the body anti-shake SW information of the anti-shake display data 220, thereby producing an effect that a user can easily recognize the settings (validity/invalidity) of the anti-shake functions respectively comprised by the taking lens 100 and the camera body 500.

Furthermore, the segments Seg1 and Seg2 are displayed on the liquid crystal monitor 212, the display panel 501 and the finder 502 according to the attachment information and the anti-shake correspondence information of the anti-shake display data 220, thereby producing an effect that a user can easily recognize whether or not the taking lens 100 is attached to the camera body 500, and whether or not the attached taking lens 100 comprises the anti-shake function.

As described above, according to the present invention, an easy, low-cost and high-speed camera system, in which at least either of a taking lens and a camera body comprises a image shake correction function, and with which a user can operate his or her desired image shake correction function with a simple operation, can be provided.

What is claimed is:

1. A camera system where a taking lens and a camera body respectively comprise a image shake correction unit for correcting a shake, which occurs on an image on an image capturing surface due to a jiggle of the camera system at the time of shooting, wherein:
the taking lens and the camera body respectively comprise a communication unit for making a communication between the taking lens and the camera body; and
a control is performed so that the communication unit of the camera body transmits a lens operation suspension instruction when the image shake correction unit of the camera body is operated, and an operation of the taking lens is suspended when the communication unit of the taking lens receives the lens operation suspension instruction.

2. The camera system according to claim 1, wherein
a control is performed to suspend at least driving of a focus lens and an operation of the image shake correction unit of the taking lens, when the communication unit of the taking lens receives the lens operation suspension instruction.

3. The camera system according to claim 1, wherein
a control is performed to suspend at least an operation of the image shake correction unit of the taking lens, when the communication unit of the taking lens receives the lens operation suspension instruction.

4. The camera system according to claim 1, further comprising:
a lens anti-shake switch for setting validity/invalidity of the image shake correction unit comprised by the taking lens;
a body anti-shake switch for setting validity/invalidity of the image shake correction unit comprised by the camera body; and
an anti-shake selection processing unit for selecting, with higher priority, any one of the image shake correction units of the taking lens and the camera body according to settings of the lens anti-shake switch and the body anti-shake switch, wherein
a control is performed to operate the image shake correction unit of the camera body, when the image shake correction unit of the camera body is selected by the anti-shake selection processing unit.

5. The camera system according to claim 1, wherein
the lens operation suspension instruction is transmitted prior to a start of exposure.

6. The camera system according to claim 1, wherein
a control is performed to suspend an operation of the taking lens within a predetermined amount of time shorter than a release time lag of the camera body, when the communication unit of the taking lens receives the lens operation suspension instruction.

7. The camera system according to claim 1, wherein:
the lens operation suspension instruction includes information of a suspension time until an operation of the taking lens is suspended; and
a control is performed to suspend the operation of the taking lens within the suspension time, when the communication unit of the taking lens receives the lens operation suspension instruction.
